(19) United States
(12) Patent Application Publication
(10) Pub. No.: US 2008/0283257 A1
(43) Pub. Date: Nov. 20, 2008

(54) Mulcher apparatus and cutter element and/or tooth assembly therefor

(75) Inventor: John W. Edwards, Arcadia, FL (US)

Correspondence Address: NIXON & VANDERHYE, PC, 901 NORTH GLEBE ROAD, 11TH FLOOR, ARLINGTON, VA, 22203, US

(73) Assignee: Attachment Technologies Incorporated, Cedar Rapids, IA (US)

(21) Appl. No.: 12/153,230

(22) Filed: May 15, 2008

Related U.S. Application Data
(60) Provisional application No. 60/924,464, filed on May 16, 2007.
(60) Provisional application No. 60/960,862, filed on Oct. 17, 2007.

(51) Int. Cl. A01B 23/02

(52) U.S. Cl. 172/256; 172/681; 172/518

(57) ABSTRACT

A mulcher apparatus includes a tractor and a mulcher unit provided to the tractor. The mulcher unit includes a tooth assembly with a holder and a cutter element with a cooperating notch portion and cross bar arrangement. The notch portion can be retrofit to existing holder arrangements. The cutter element may include various features, to enhance cutting efficiency. For example, the cutter elements may include a double-ended structure, a relatively wide serrated cutting edge at one or both ends, carbide coatings, layers or inserts, etc.

### CROSS REFERENCE TO RELATED APPLICATIONS

This application claims the benefit of U.S. Provisional Application Nos. 60/924,464, filed May 16, 2007, and 60/960,862, filed Oct. 17, 2007, each of which is incorporated herein by reference in its entirety.

### BACKGROUND OF THE INVENTION

1. Field of the Invention

This invention relates to an industrial mulcher apparatus for use in mulching vegetation such as brush, trees, etc., or stump grinding. In particular, the invention relates to improvements to a mulcher unit including a plurality of cutter assemblies that serially engage and mulch the intended vegetation in rapid fashion.

2. Description of Related Art

FIGS. 1-5 illustrate a related art mulcher apparatus 10. The mulcher apparatus 10 includes a tractor 12 supported on one or more wheels 14 and/or tracks. A tractor driver can sit within a protected cage 16 positioned on a frame of the mulcher apparatus 10. A hydraulic unit 18 connected to the tractor 12 provides structure by which a mulcher unit 20 is positioned, e.g., laterally shifted, raised and/or lowered. The tractor 12 is commercially available from Barco, a manufacturer of tractors. The term “tractors” is intended to encompass traditional tractors, as well as loaders, skid steers, feller bunchers, etc. Also, many details of the mulcher apparatus 10 shown in FIG. 1 are described in U.S. Pat. Nos. 5,813,792 and 6,484,811, herein incorporated by reference in their entirety.

The tractor 12 is provided with one or more power sources, e.g., motors, sufficient to drive the tractor at a desired speed and to rotate the mulcher unit 20 in the direction of arrow A. The mulcher unit 20 can rotate at a speed of about 1,700 rpm, for example.

As shown in FIG. 2, the mulcher unit 20 includes a power driven rotatable shaft 22 on which a plurality of axially spaced support disks 24 are mounted. Each disk 24 includes a through hole 26 through which a support rod 28 is guided and secured, e.g., via welding. The mulcher unit 20 includes a plurality of tooth assemblies 30 each supported on the support rods 28. Each tooth assembly 30 includes a base portion 32 and a head portion 34. The head portion 34 includes a cutter element 36 described below.

As shown in FIG. 3, each base portion 32 includes one or more through holes 38 through which the support rods 28 are guided in order to support each tooth assembly 30 in a non-rotatable fashion. FIG. 3 also shows that the cutter element 36 includes a primary cutter element 40. A deflecting element or secondary cutter element 42 is provided on a central portion 43 of the tooth assembly 30 which is intermediate the base portion 32 and the head portion 34. The primary cutter element 40 may include a tip portion 44 made of a carbide material which is provided, e.g., welded or glued, to a base portion 46 of the primary cutter element 40.

Referring back to FIG. 2, the cutter element 36 is connected to the head portion 34 of the tooth assembly 30 as follows. The base portion 46 of the cutter element 36 is provided with a shroud 48 which is integrally formed with and extends away from a rear side 31a of the cutter element 36. The shroud 48 is generally oval or hour-glass shaped (see FIG. 7 and description below) and includes a pair of pre-threaded bores 33 for receiving a pair of bolts 50. The head portion 34 of the tooth assembly is provided with a countersunk aperture matching the shape of the shroud 48 so that, upon assembly, the cutter element 36 and the head portion 34 fit together like a puzzle. In FIG. 2, the bolts 50 and the shroud 48 of one of the tooth assemblies 30 are shown in phantom to facilitate understanding of the connection between the cutter element 36 and the head portion 34.

FIGS. 4 and 5 show alternative versions of the cutter element. FIG. 4 includes a cutter element 36′ having a pair of tip portions 44′ provided on a base portion 46′. FIG. 5 illustrates a cutter element 36″ including first and second rows of tip portions 44″ that are provided to a base portion 46″.

There are several disadvantages associated with the mulcher apparatus shown in related art FIGS. 1-5. In particular, with respect to the connection between the cutter element 36 and the head portion 34, the provision of a raised shroud 48 with pre-threaded bores requires difficult machining operations and is therefore relatively expensive to manufacture. In addition, the mounting assembly for mounting the tooth assembly 30 to the rotatable shaft 22 is difficult and cumbersome, in part, because it requires a plurality of support disks 24 having bores 26 for receiving rods 28. Also, the central portion 43 requires a secondary cutter or deflecting element since it may inadvertently contact the intended target. Finally, the positioning of each tooth element is such that a significant number of the cutter elements 36 may contact the intended target at the same time, thereby slowing rotation of the shaft 22 with a commensurate decrease in power. While U.S. Patent Publication No. US-2005-0098331-A1, incorporated herein by reference in its entirety, describes a mulcher apparatus which addresses one or more of the above-noted deficiencies, there is a continuing need in the art to develop stronger and more efficient systems.

### BRIEF SUMMARY OF THE INVENTION

One aspect of the invention relates to providing a mulcher apparatus including a mulcher unit and/or cutter assembly with improved cutting efficiency and cost effectiveness for labor and/or replacement parts.

Another aspect is to provide an improved tool assembly that may be retrofit to existing mulcher apparatus.

According to one embodiment, a cutter element for a mulcher apparatus comprises a main body including a rear portion configured to be mounted on a cutter element receiving surface of a holder and a front portion including at least one cutting portion, said rear portion including at least one bore provided in the main body, wherein the cutting portion includes a serrated edge extending at least partially across a width of the main body.

According to another embodiment, a cutter element for a mulcher apparatus comprises a main body including a rear portion configured to be mounted on a cutter element receiving surface of a holder and a front portion including at least one cutting portion, wherein the cutting portion includes a top surface that is positioned towards the rear portion of the main body such that a tip or leading edge of the cutting portion is higher than the rear portion or trailing edge of the main body.

According to another embodiment, a cutting portion for a mulcher apparatus comprises a main body including a rear portion configured to be mounted on a cutter element receiving surface of a holder and a front portion including at least one cutting portion, wherein the cutting portion has a cutting edge that is wider than the main body.

According to another embodiment, a cutter element for a mulcher apparatus comprises a main body including a front portion defining a front surface and at least one cutting portion. The cutting portion has a tip that extends forward of the front surface along a cutting direction so that the tip defines a cutting surface that, in use, is angled inwards towards a rear surface of the main body, away from material to be cut.

According to another embodiment, a mulcher apparatus comprises a drum defining an axis of rotation and at least one cutter element provided to the drum. The cutter element includes a cutting surface, wherein the cutting surface is not parallel to a radial line that is perpendicular to and intersects the axis of rotation.

According to another embodiment, a cutter element for a mulcher apparatus comprises a main body having a mounting face and a front face defining at least one tooth having a tip, a primary rake face extending from the tooth tip, and a secondary rake face continuing from and angled with respect to the primary rake face.

According to another embodiment, a cutter element for a mulcher apparatus comprises a main body including a rear portion configured to be mounted on a cutter element receiving surface of a holder and a front portion including at least one cutting portion. The cutting portion includes a serrated edge extending at least partially across a width of the main body. The serrated edge is in the form of a carbide insert structured to be attached to the cutter portion.

According to another embodiment, a cutter element for a mulcher apparatus comprises a main body including a rear portion configured to be mounted on a cutter element receiving surface of a holder and a front portion including at least one cutting portion. The cutting portion includes a straight cutting edge extending at least partially across a width of the main body. The cutting portion includes a top surface with tapered or recessed portions to facilitate passage of the cutting edge through debris.

These and other aspects of the invention will be described and/or apparent from the following detailed description of illustrated embodiments.

### BRIEF DESCRIPTION OF THE DRAWINGS

Embodiments of the invention will be described in conjunction with the following drawings, in which like reference numbers refer to like parts, and wherein:

FIG. 1 illustrates a mulching apparatus according to the related art;

FIG. 2 is an enlarged partial view of the mulcher unit shown in FIG. 1;

FIG. 3 is a perspective view of a tooth assembly shown in the mulcher unit of FIG. 2;

FIGS. 4 and 5 represent alternative cutter elements according to the related art;

FIG. 6 is a portion of a mulcher apparatus according to an embodiment of the present invention;

FIGS. 6A and 6B illustrate a portion of a mulcher apparatus according to an embodiment of the present invention;

FIG. 7a is a perspective view of a holder for a cutter element according to an embodiment of the present invention;

FIG. 7b is a cross section along line 7b-7b of FIG. 7a;

FIG. 8 is a right side view of a holder for a cutter element according to another embodiment of the present invention;

FIG. 9 is a front view thereof;

FIG. 10 is a top view thereof;

FIG. 11 is a side view of a cutter element according to another embodiment of the present invention;

FIG. 12 is a right side view thereof;

FIG. 13 is a left side view thereof;

FIG. 14 is a top view thereof;

FIG. 15 is a side view of a cutter element according to another embodiment of the present invention;

FIG. 16 is a right side view thereof;

FIG. 17 is a left side view thereof;

FIG. 18 is a top view thereof;

FIG. 19 is a side view of a cutter element designed according to yet another embodiment of the present invention;

FIG. 20 is a right side view thereof;

FIG. 21 is a left side view thereof;

FIG. 22 is a top view thereof;

FIGS. 22b and 22c illustrate a cutter element according to yet another embodiment of the present invention;

FIG. 23 is a side view of a holder according to yet another embodiment of the present invention;

FIG. 24 is a top view thereof;

FIG. 25 is a right side view thereof;

FIG. 26 is a side view of a cutter element according to still another embodiment of the present invention;

FIG. 27 is a right side view thereof;

FIG. 28 is a left side view thereof;

FIG. 29 is a top view thereof;

FIG. 30 is a side view of a cutter element according to another embodiment of the present invention;

FIG. 31 is a right side view thereof;

FIG. 32 is a left side view thereof;

FIG. 33 is a top view thereof;

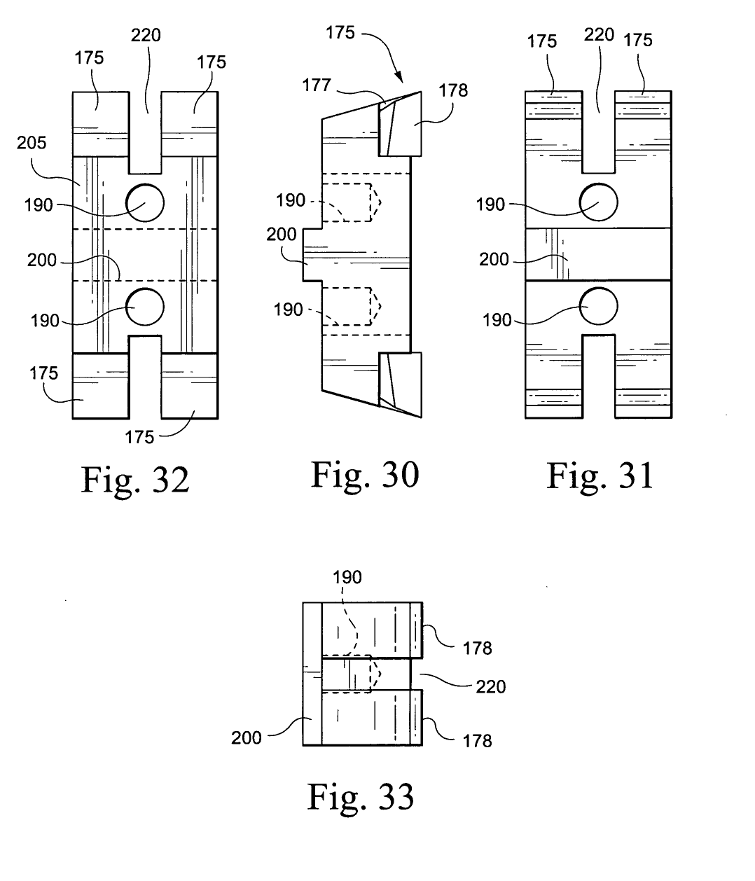

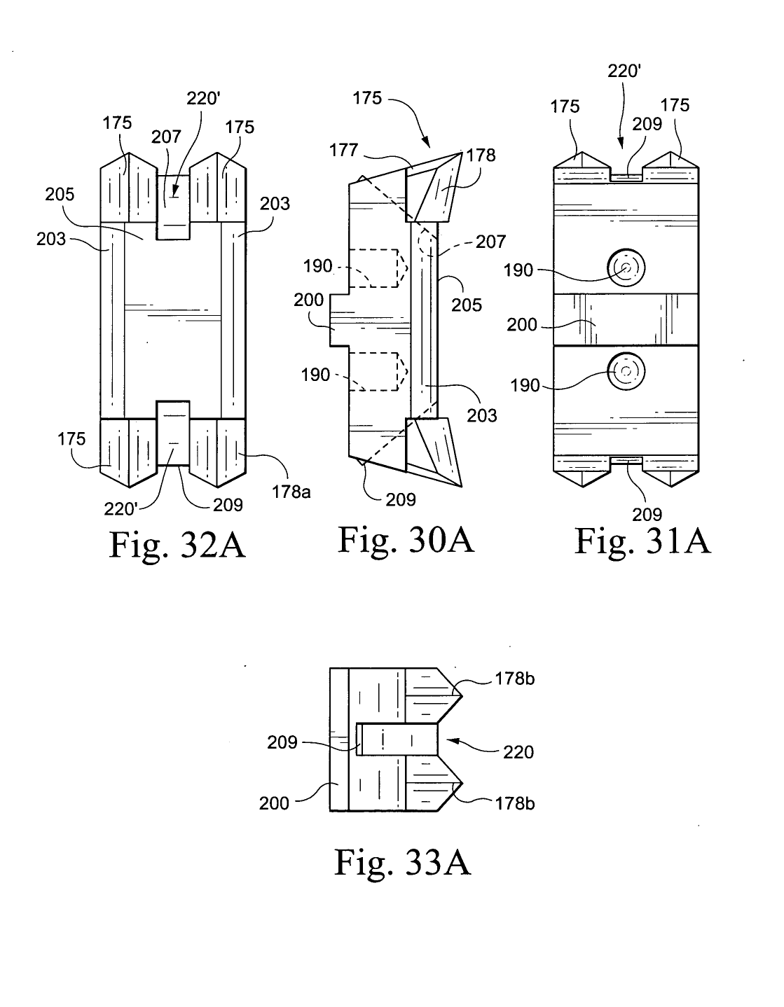

FIG. 30A is a side view of a cutter element according to another embodiment of the present invention;

FIG. 31A is a right side view thereof;

FIG. 32A is a left side view thereof;

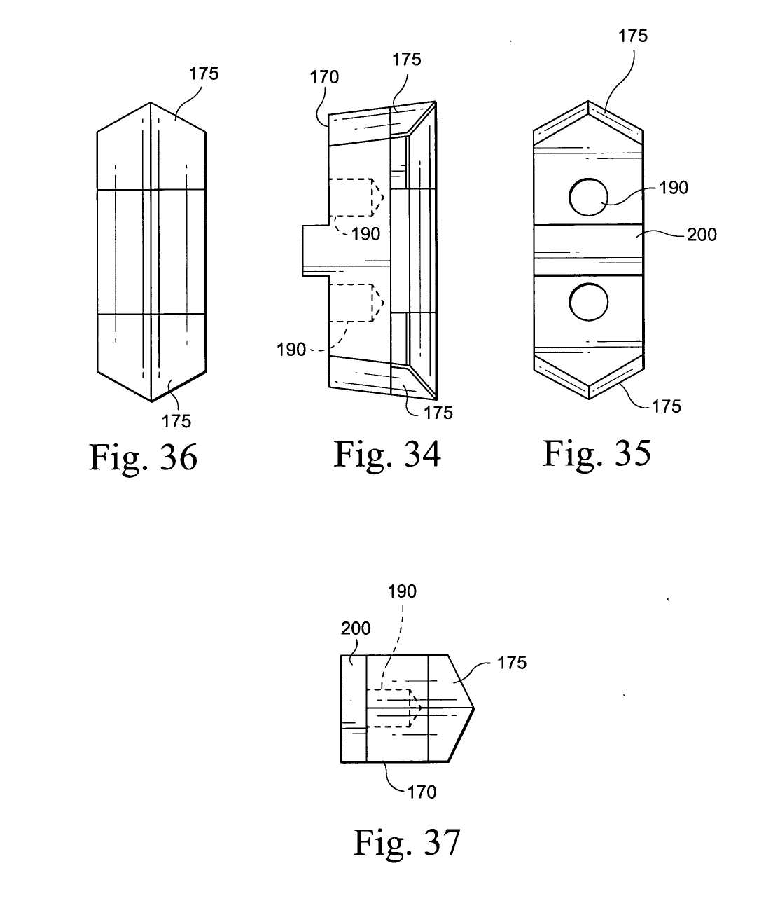

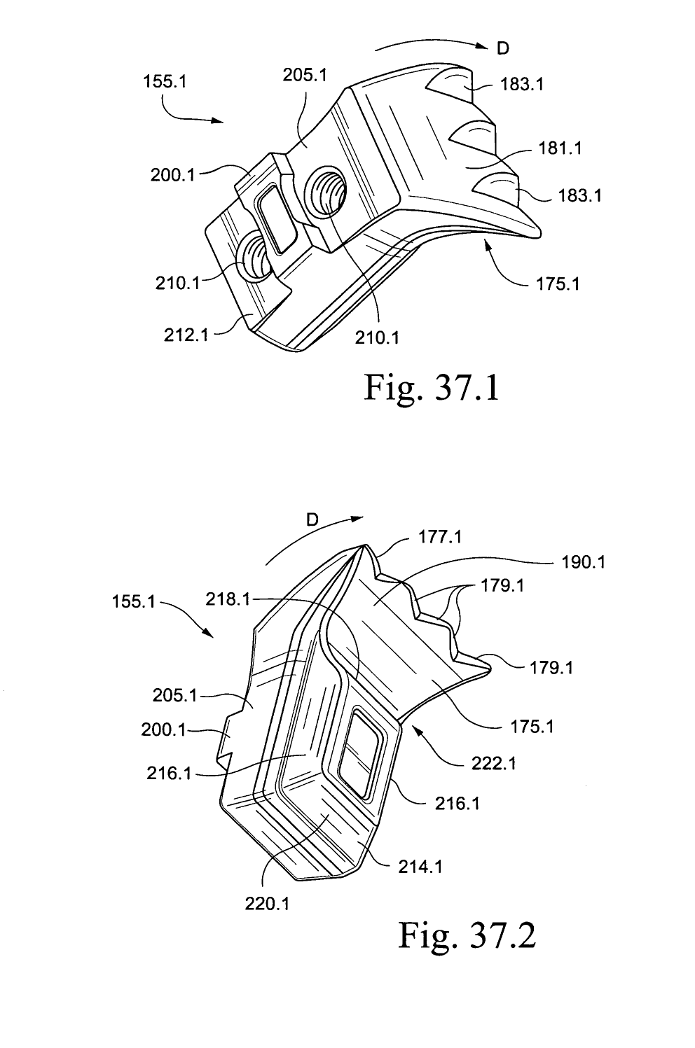

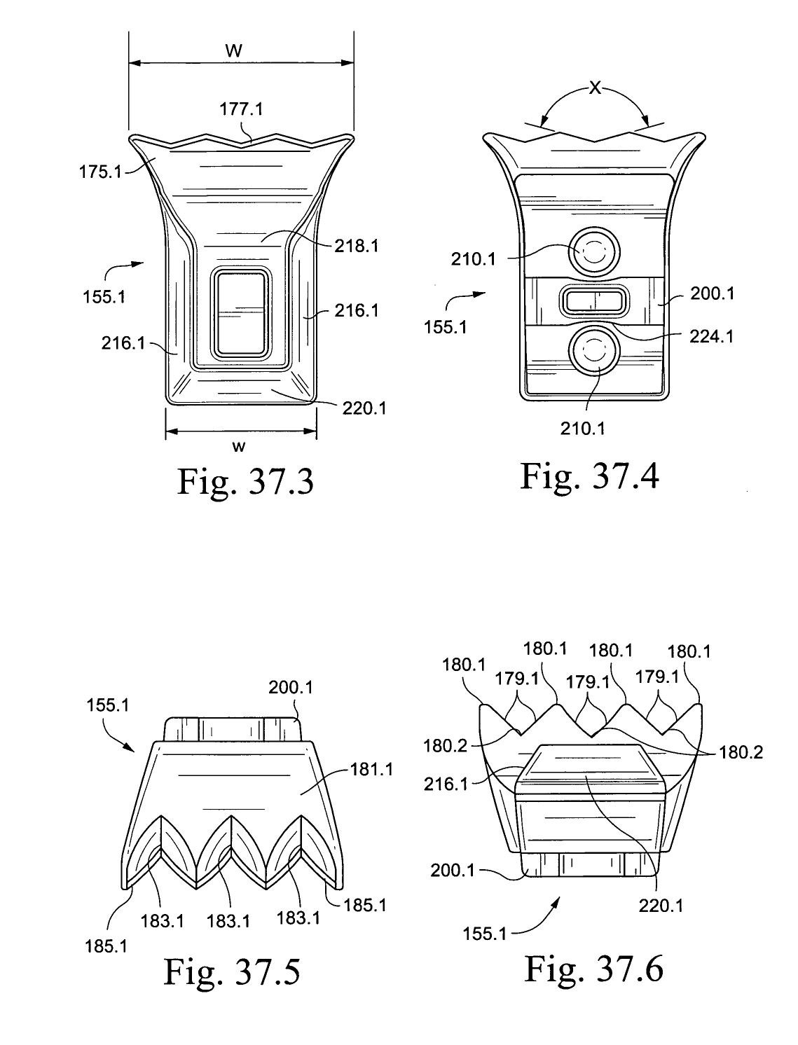

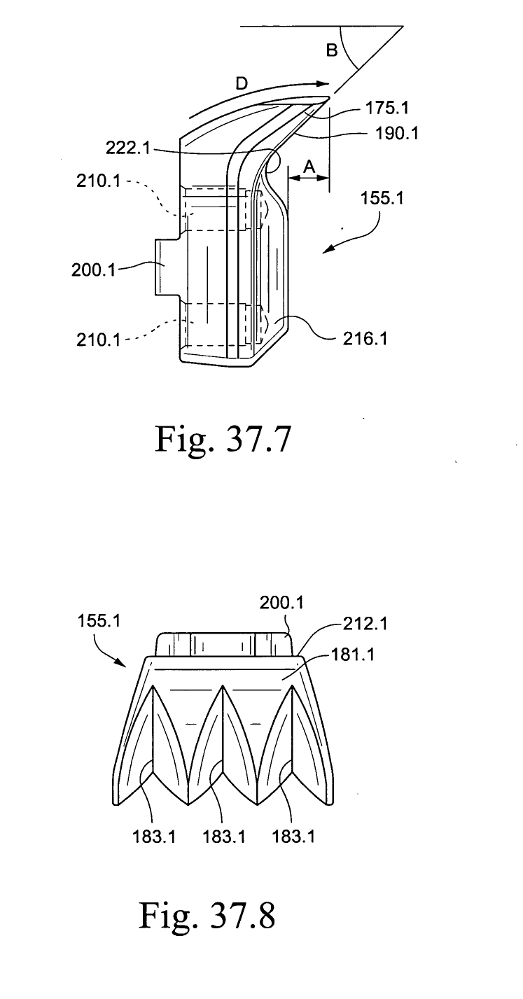

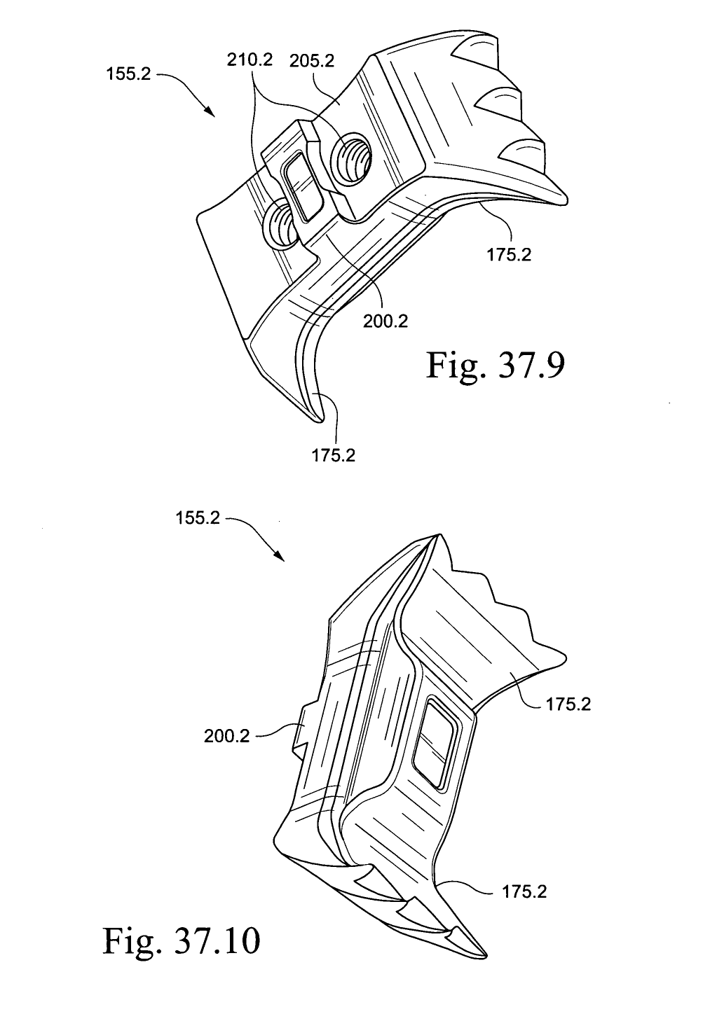

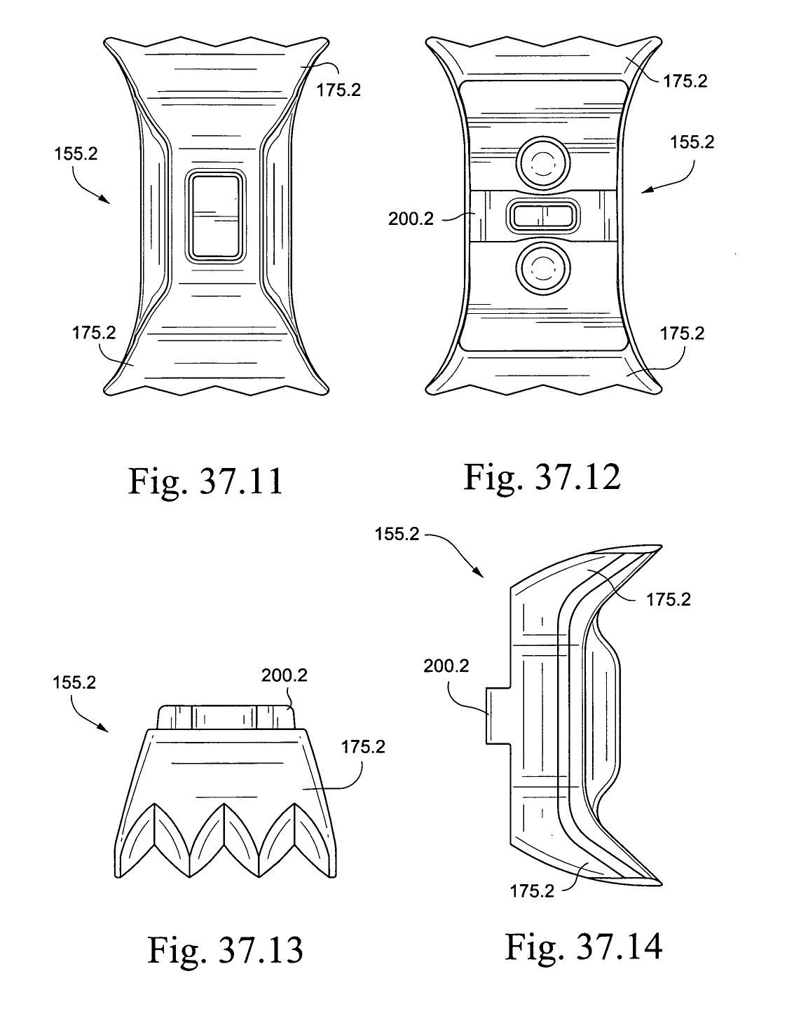

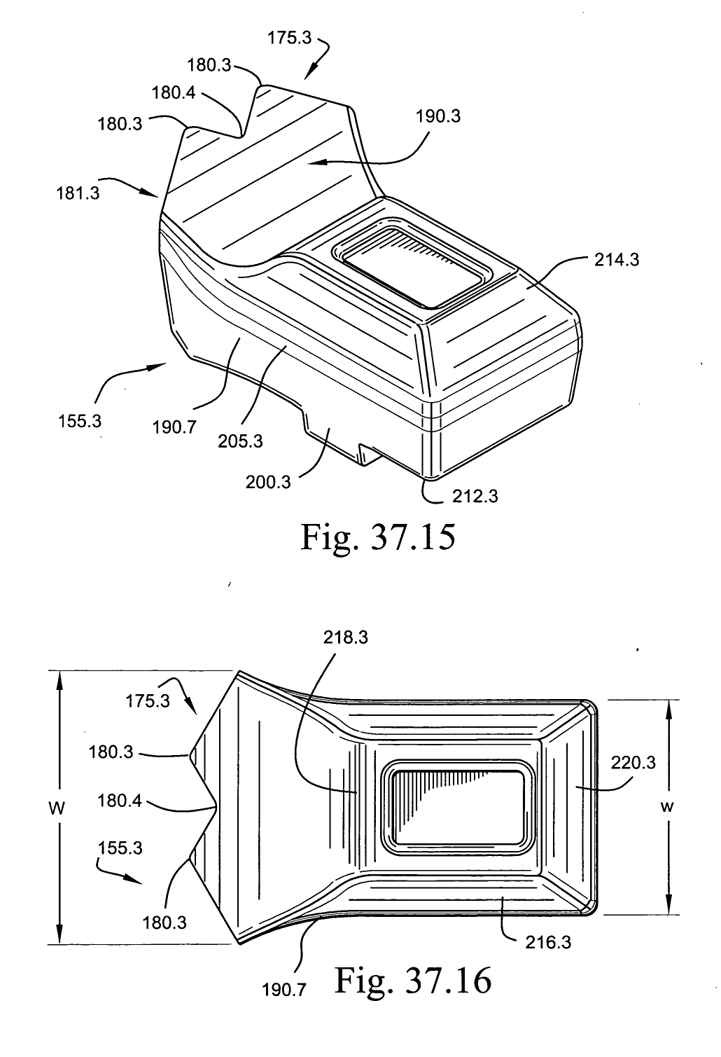

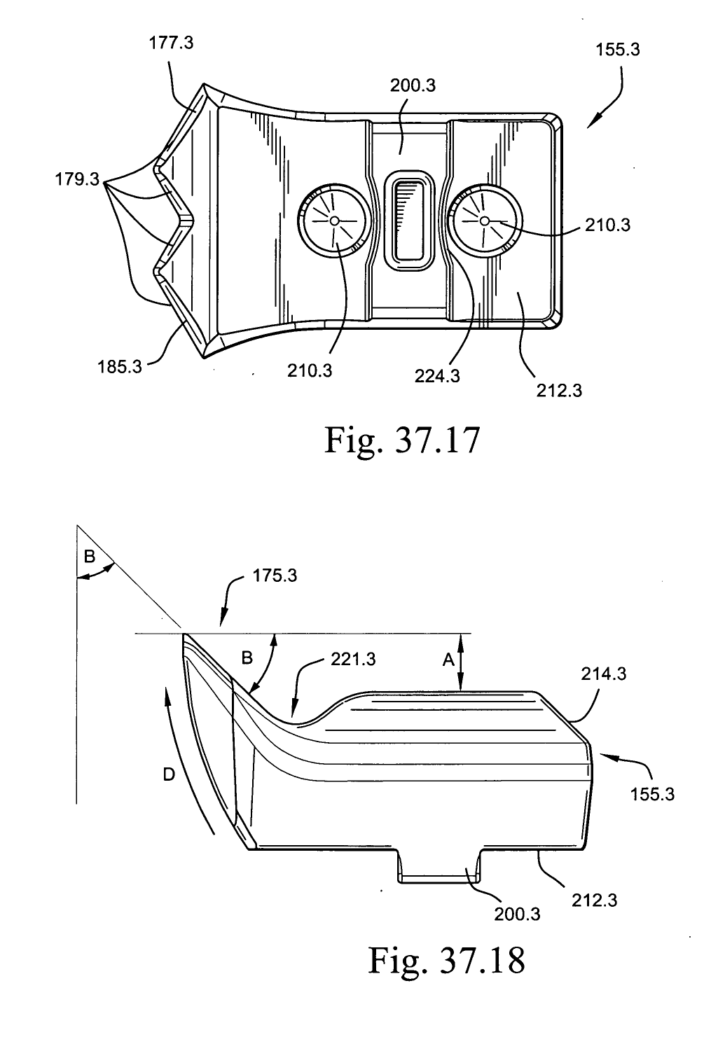

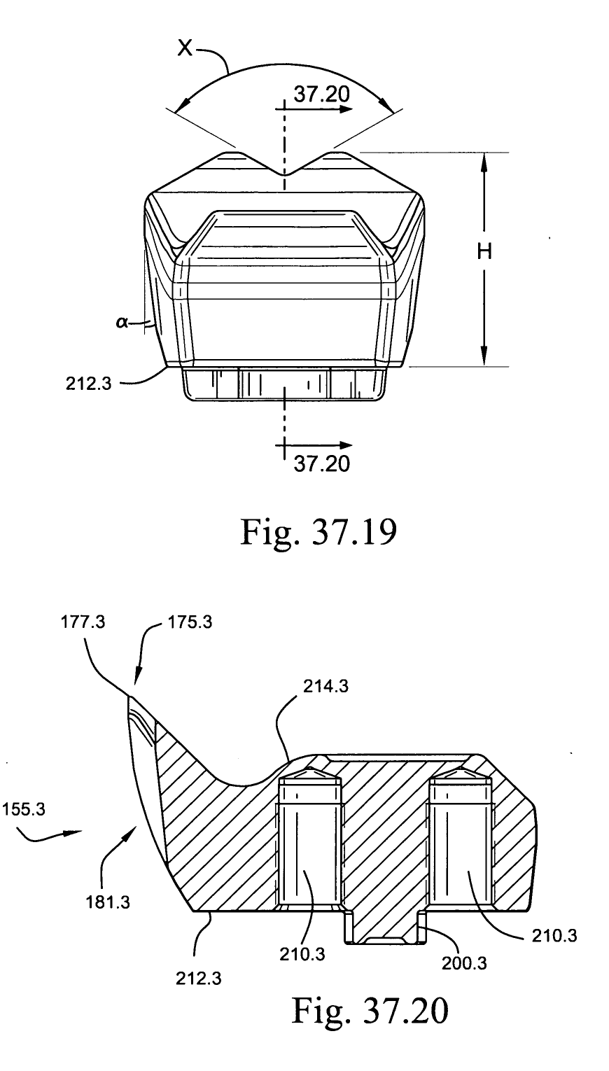

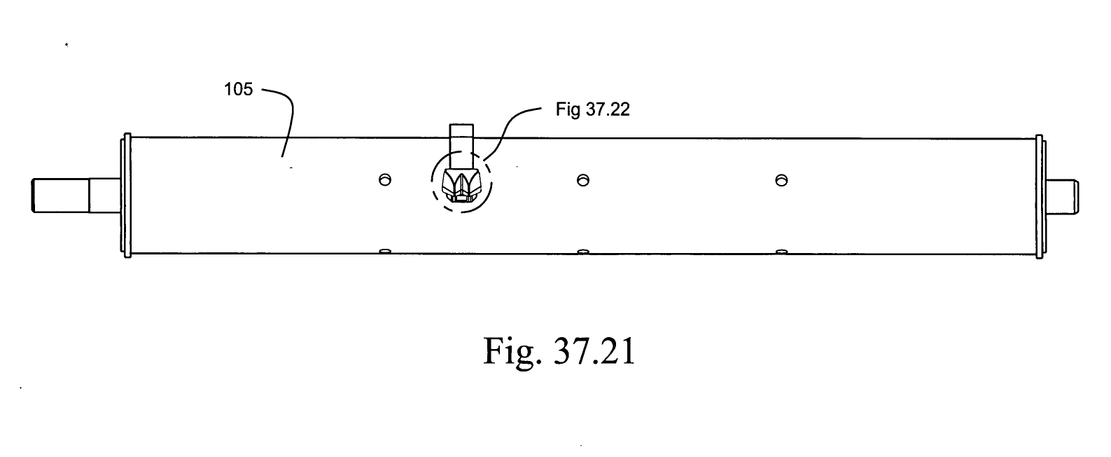

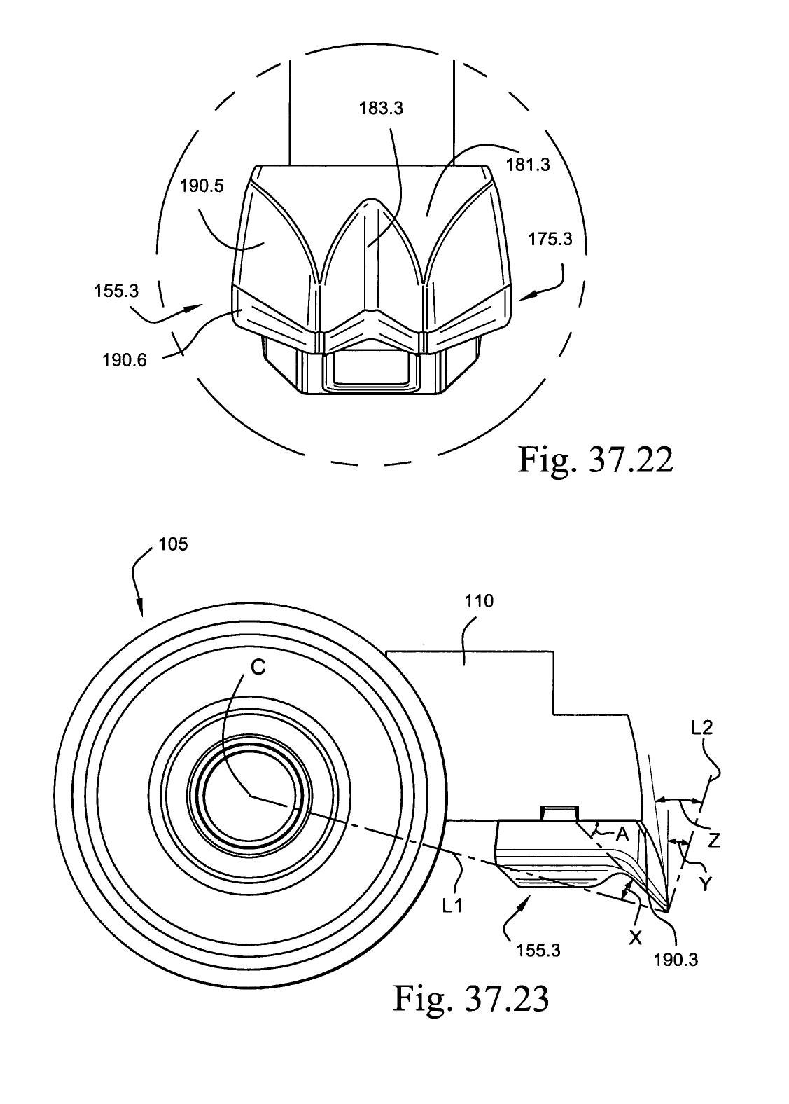

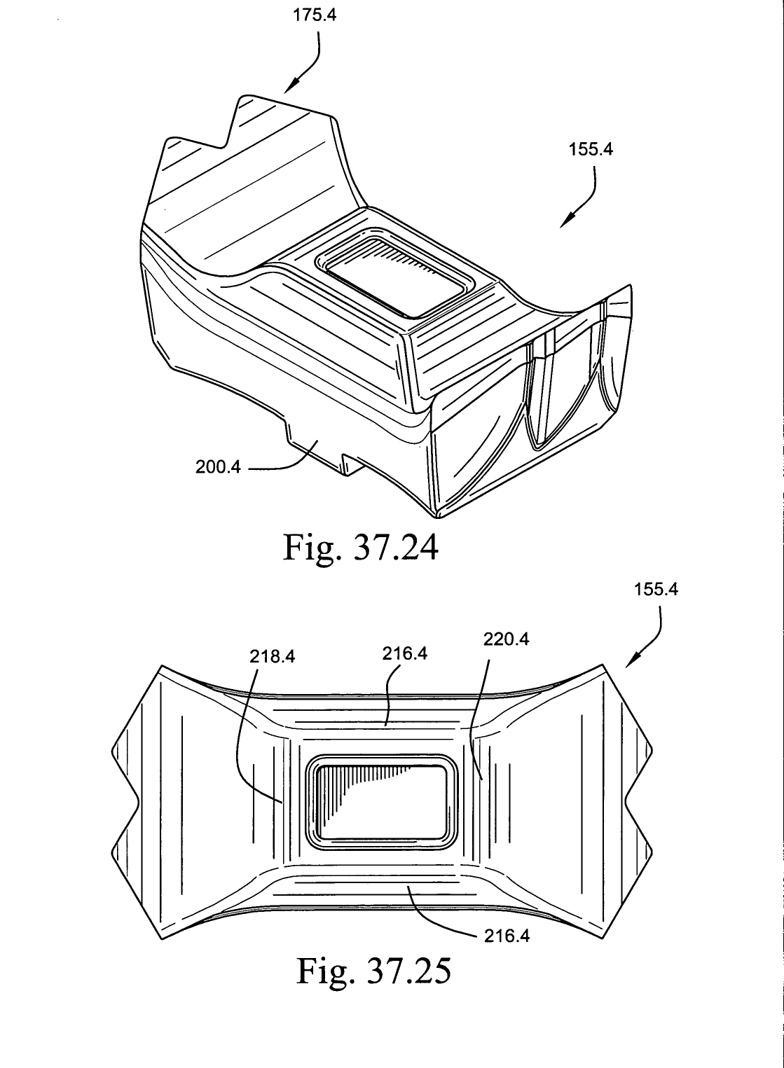

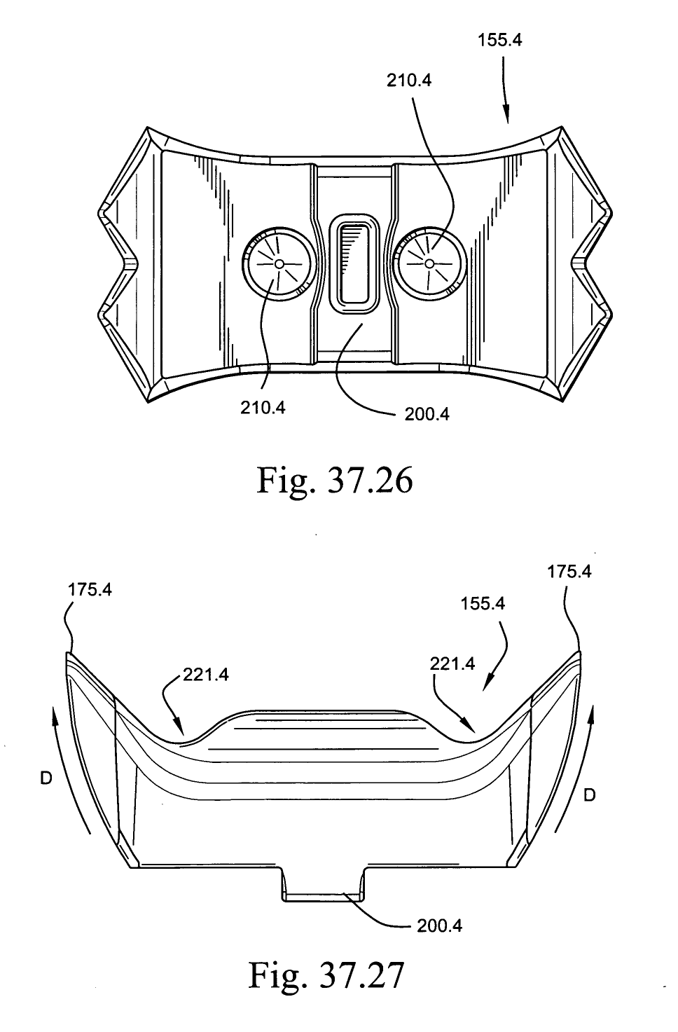

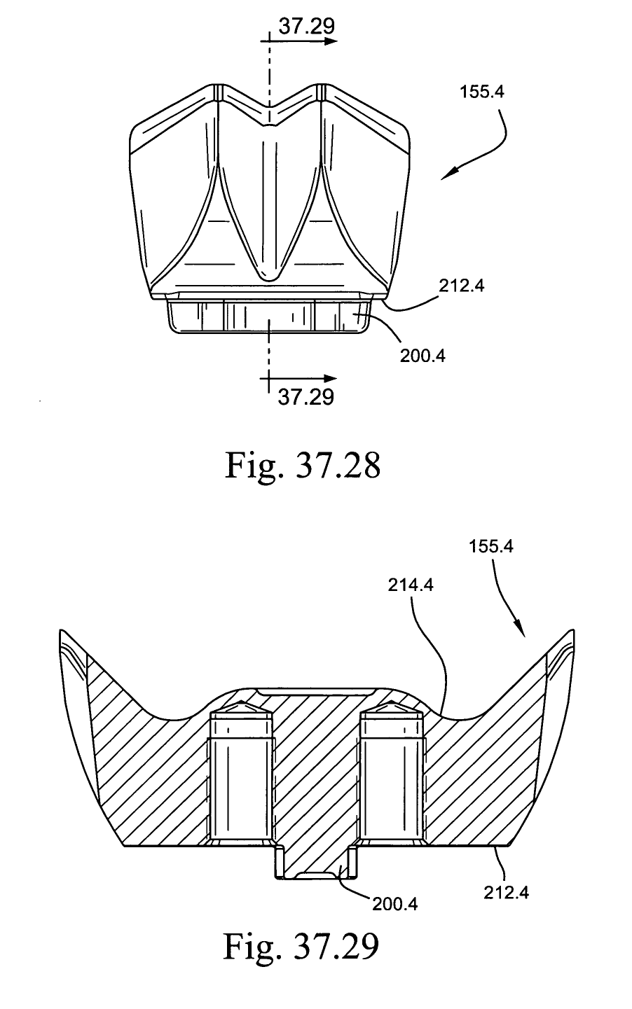

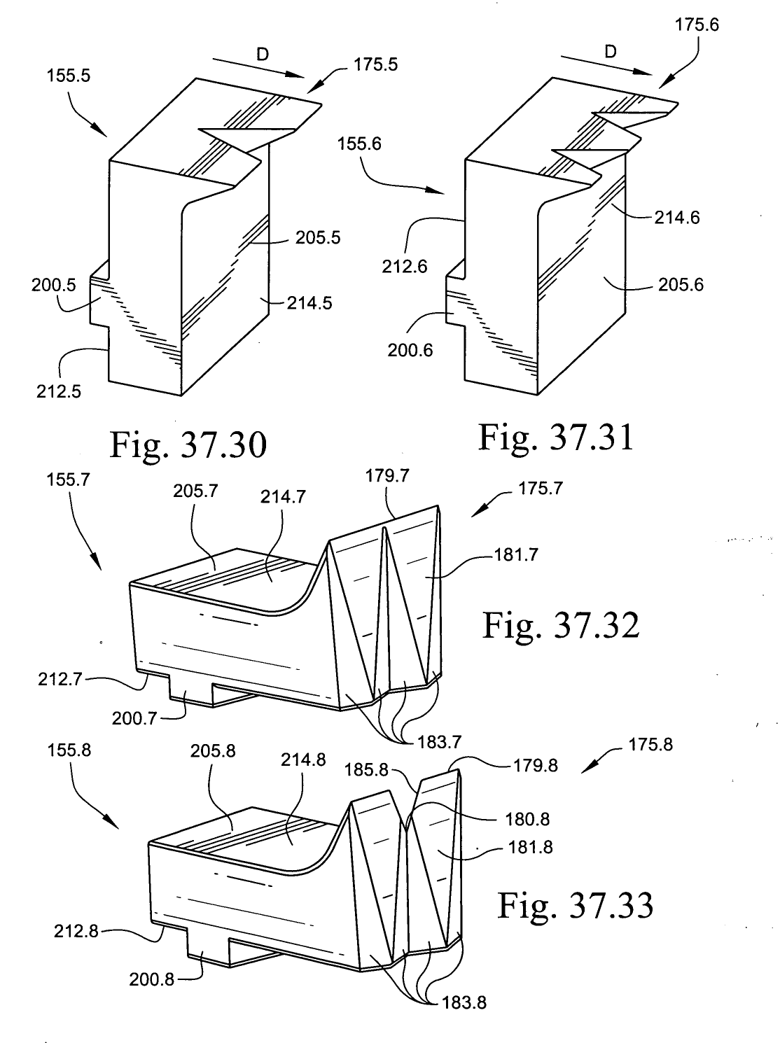

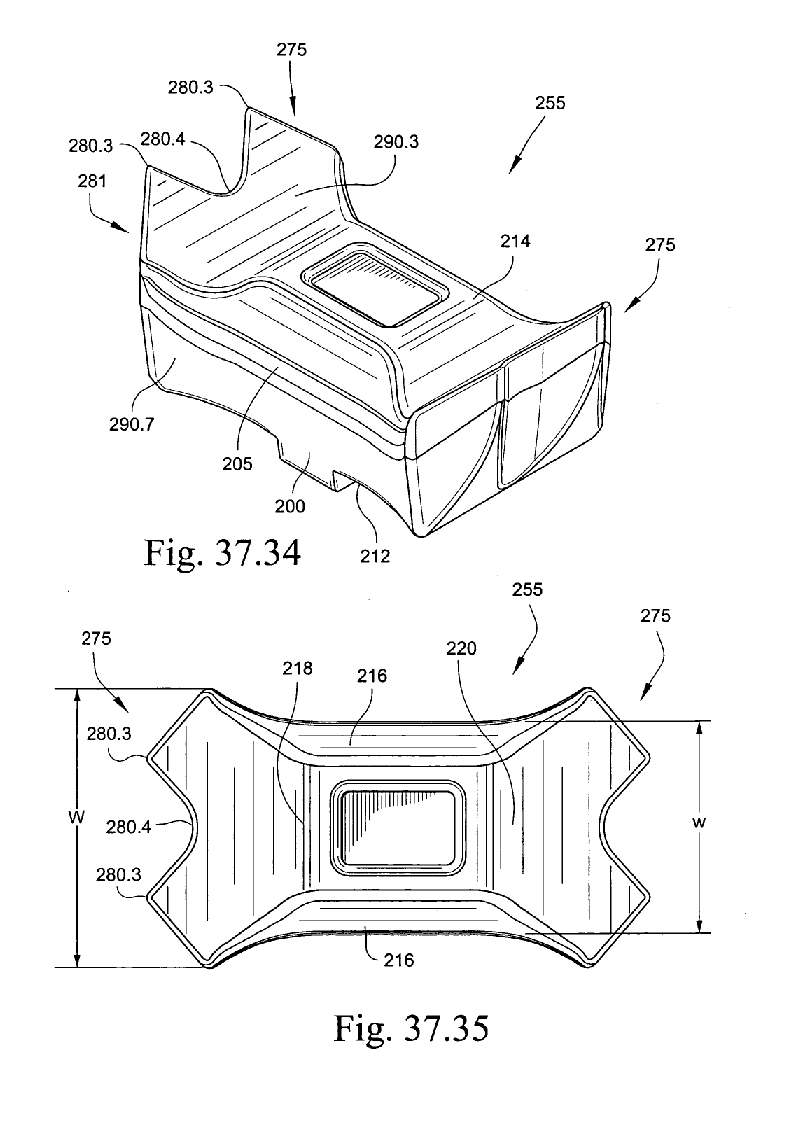

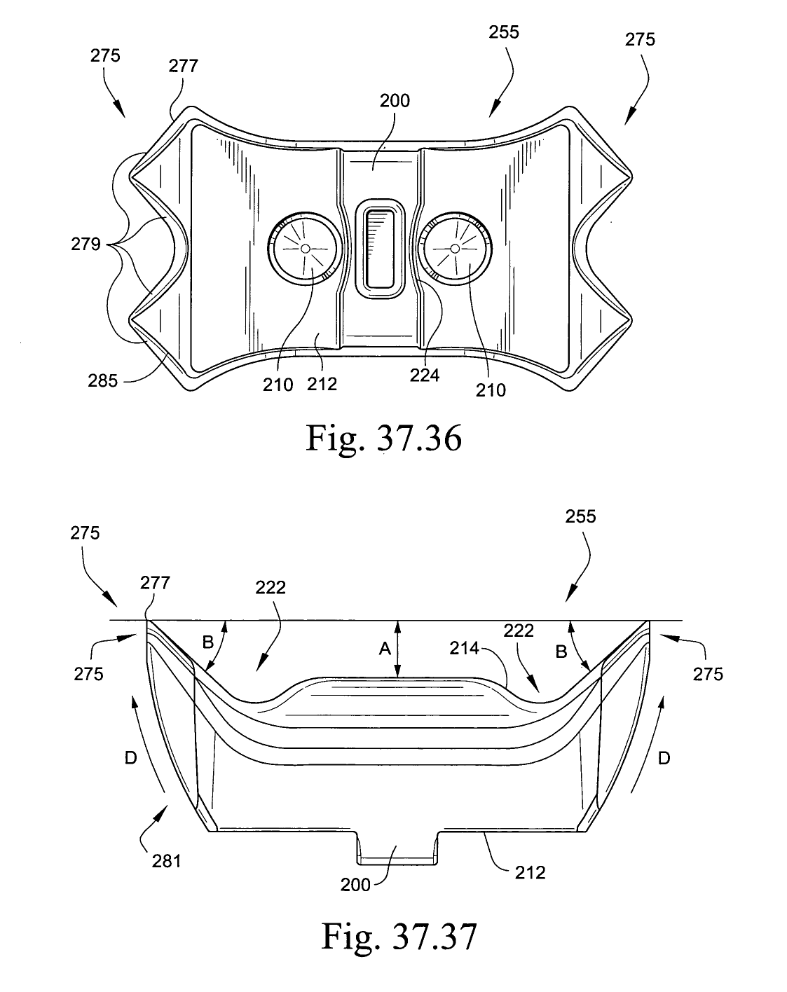

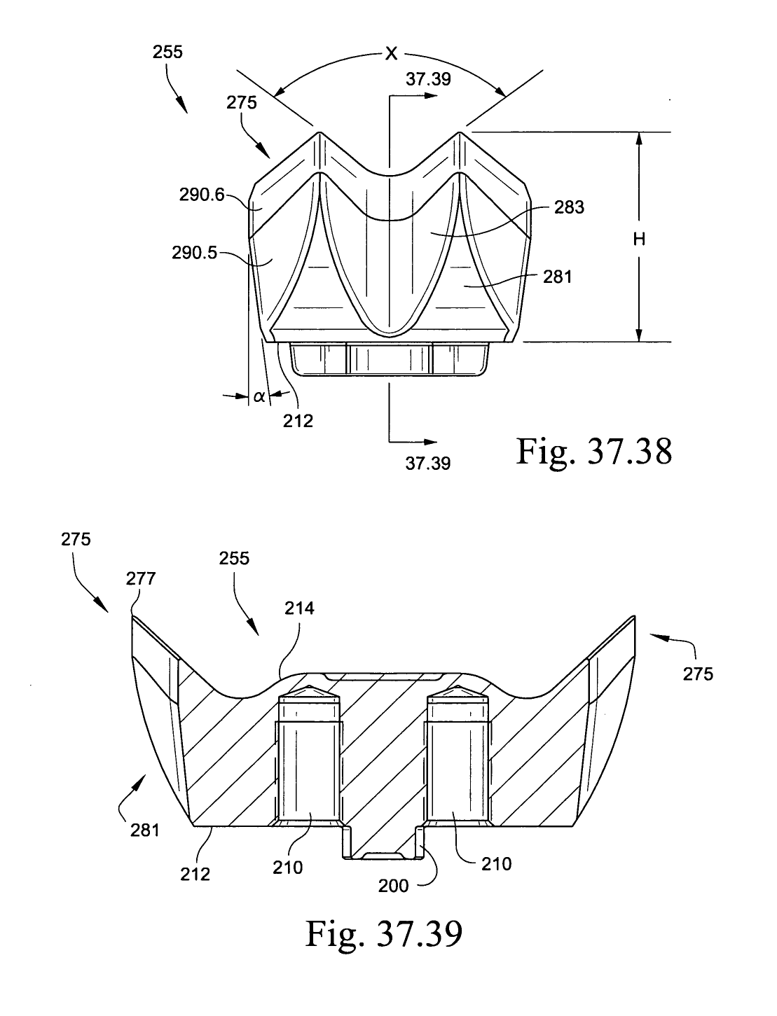

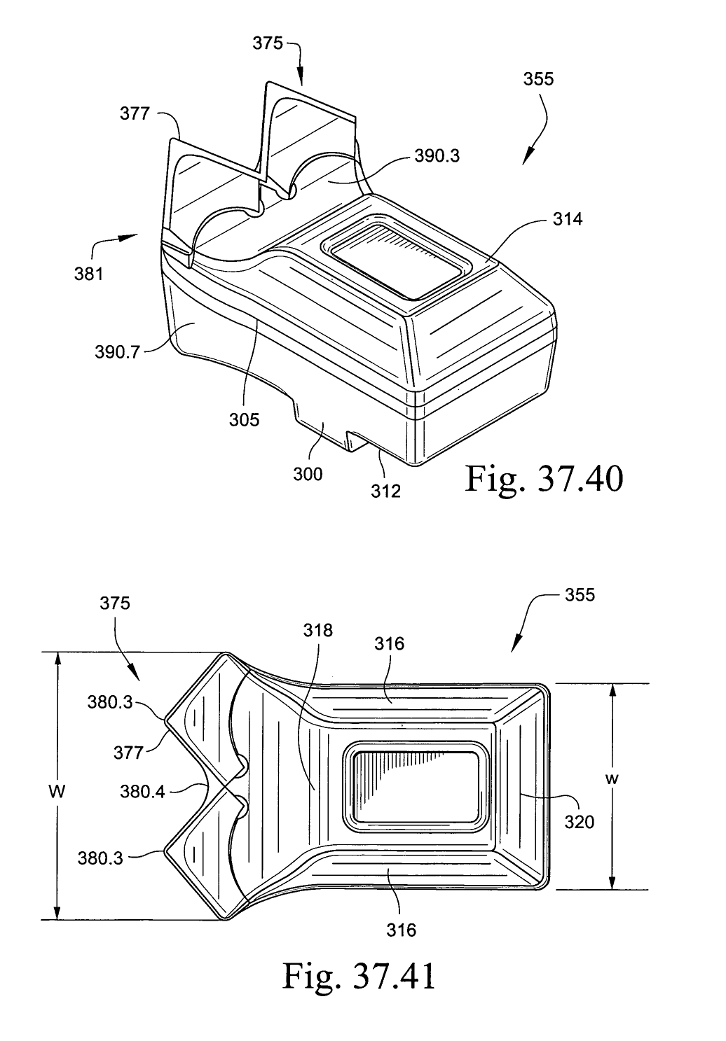

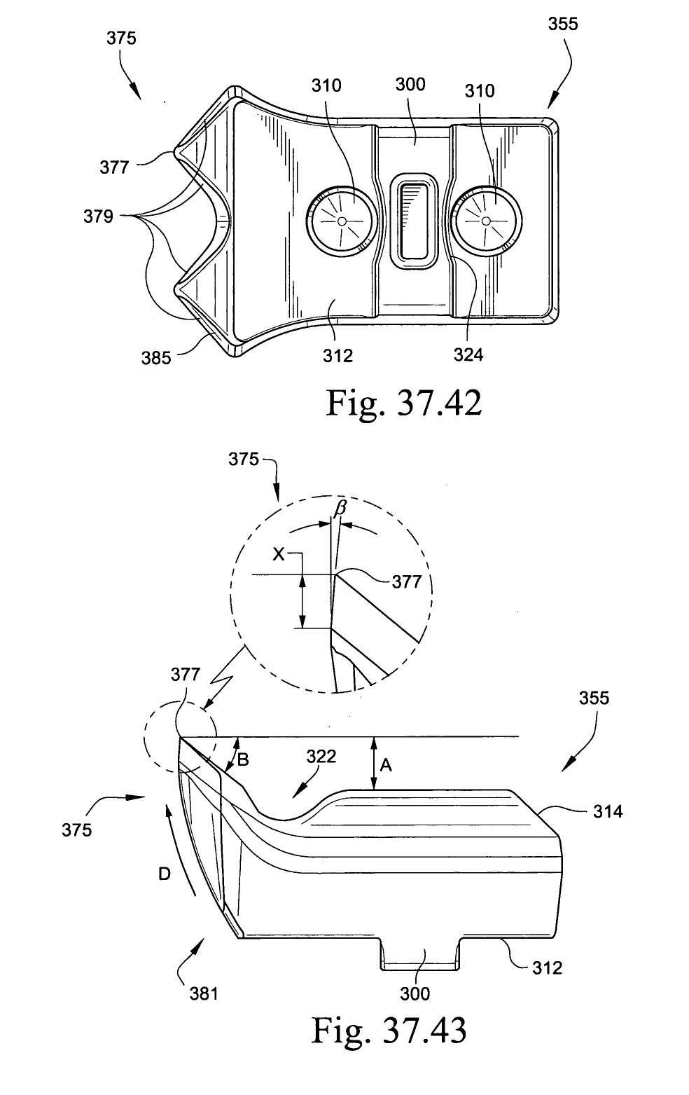

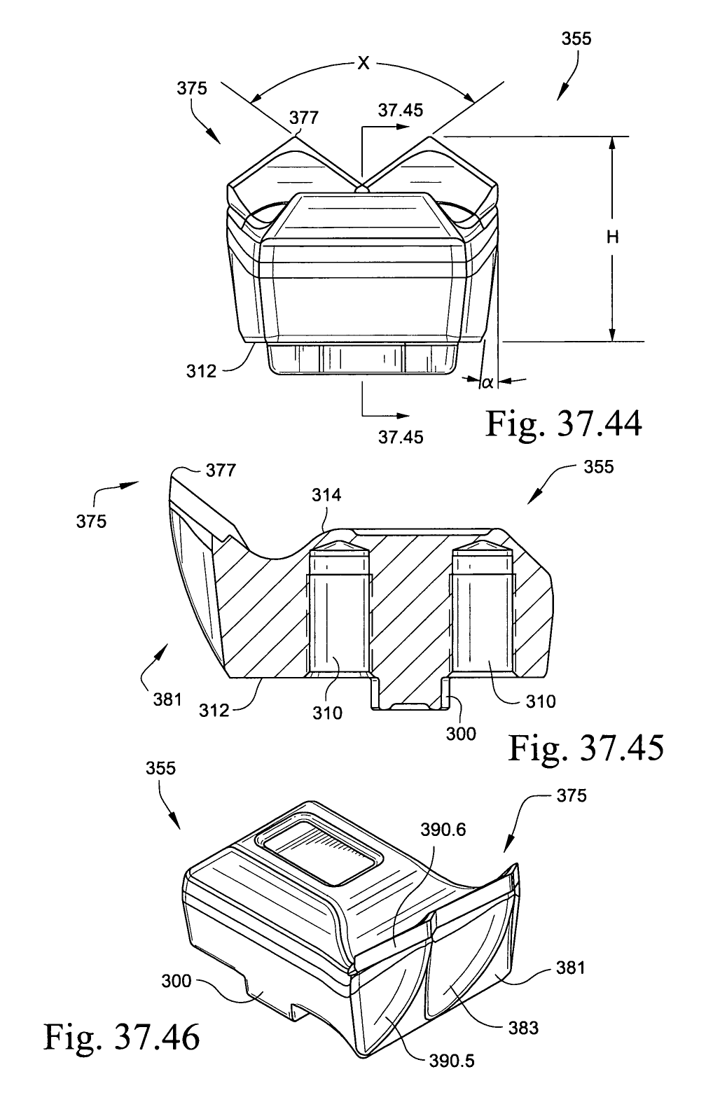

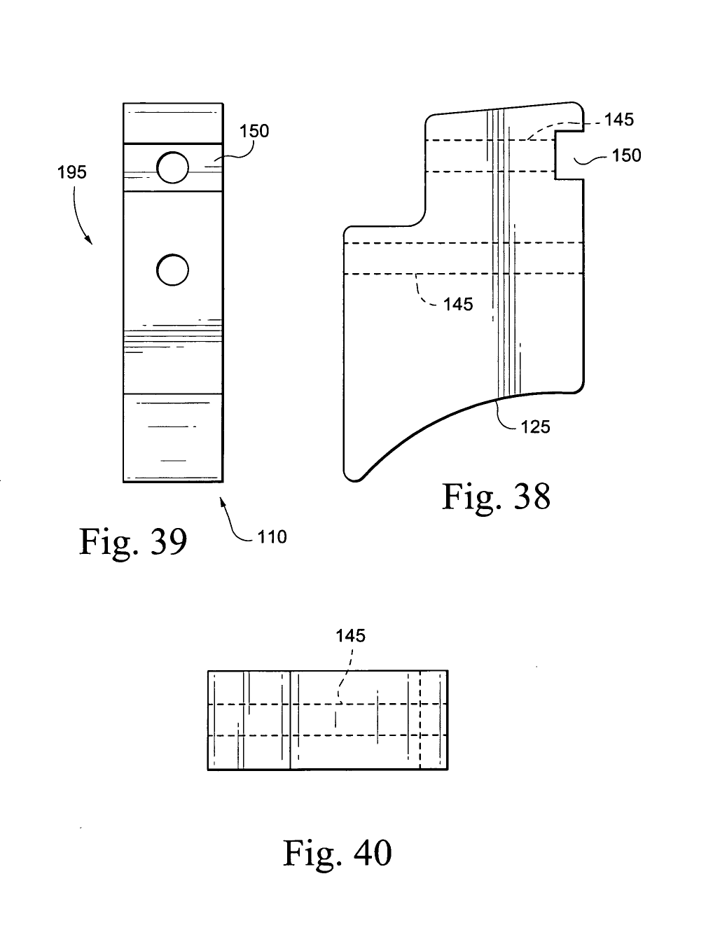

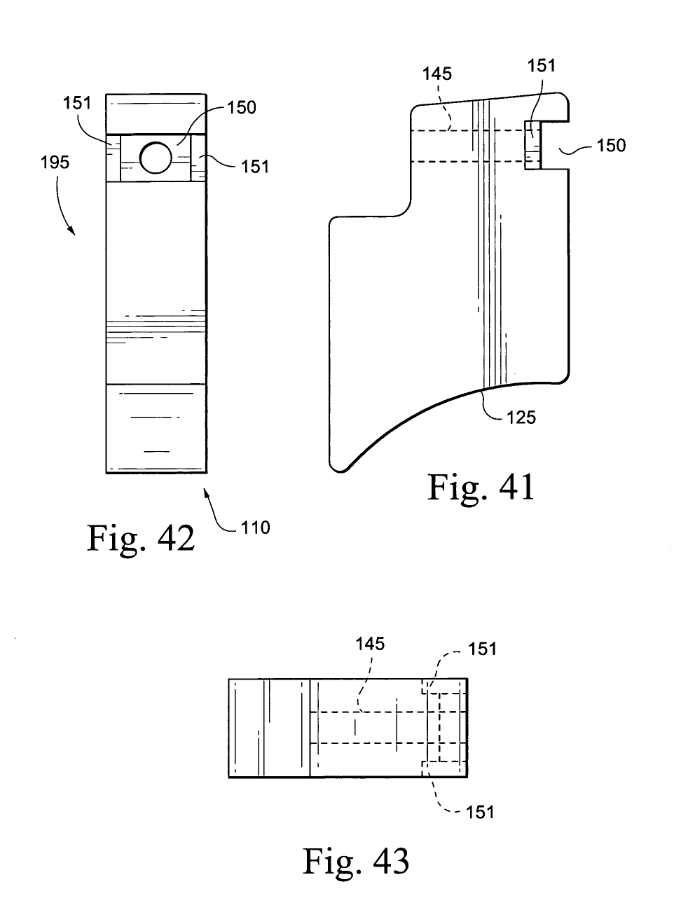

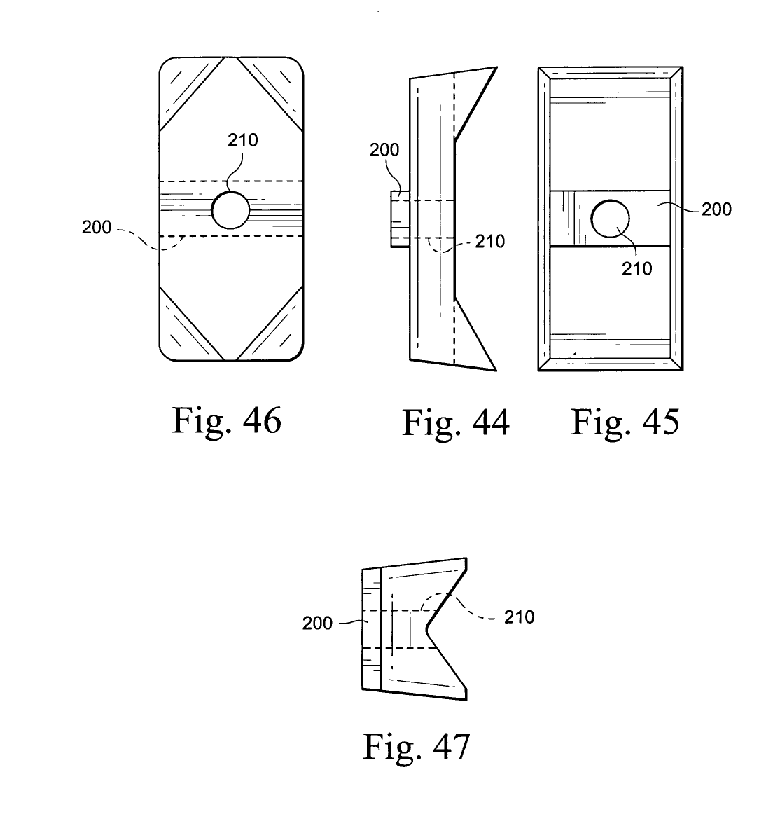

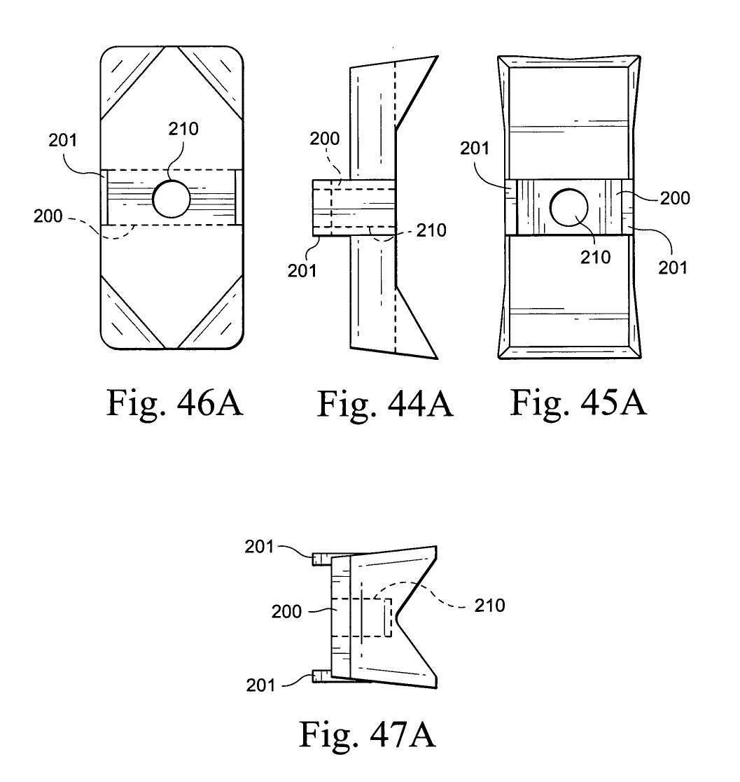

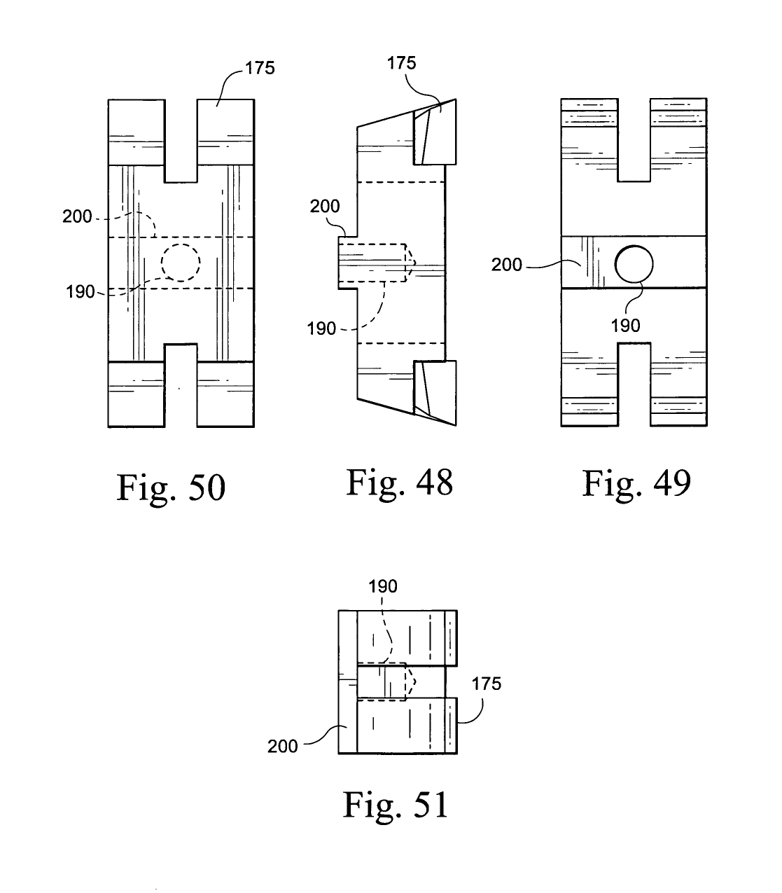

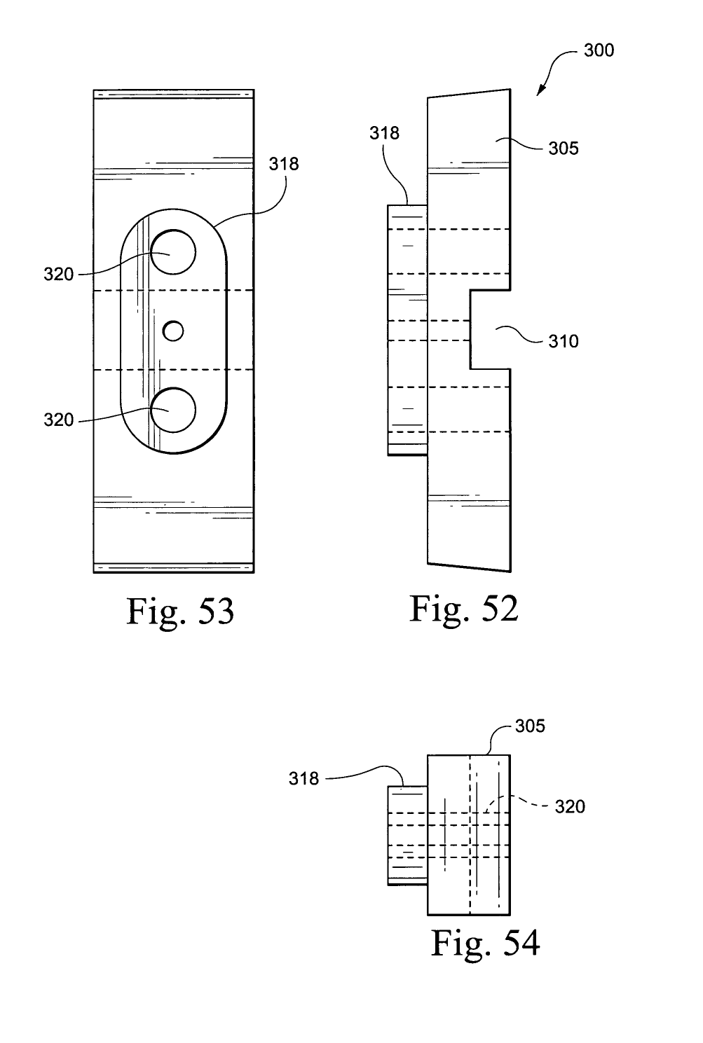

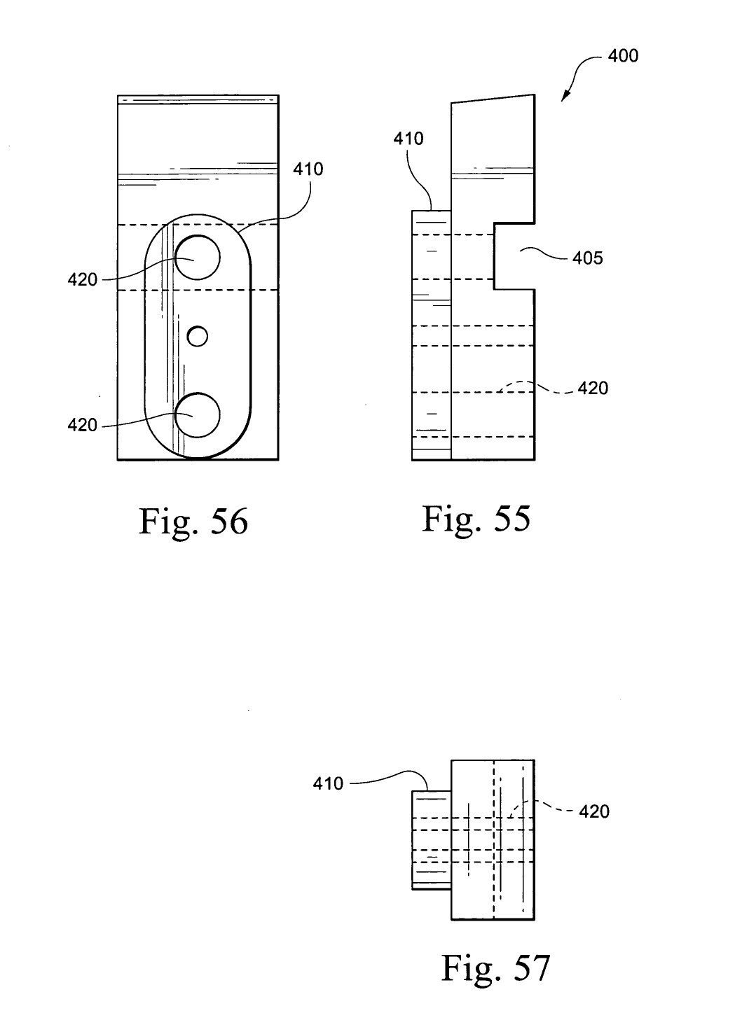

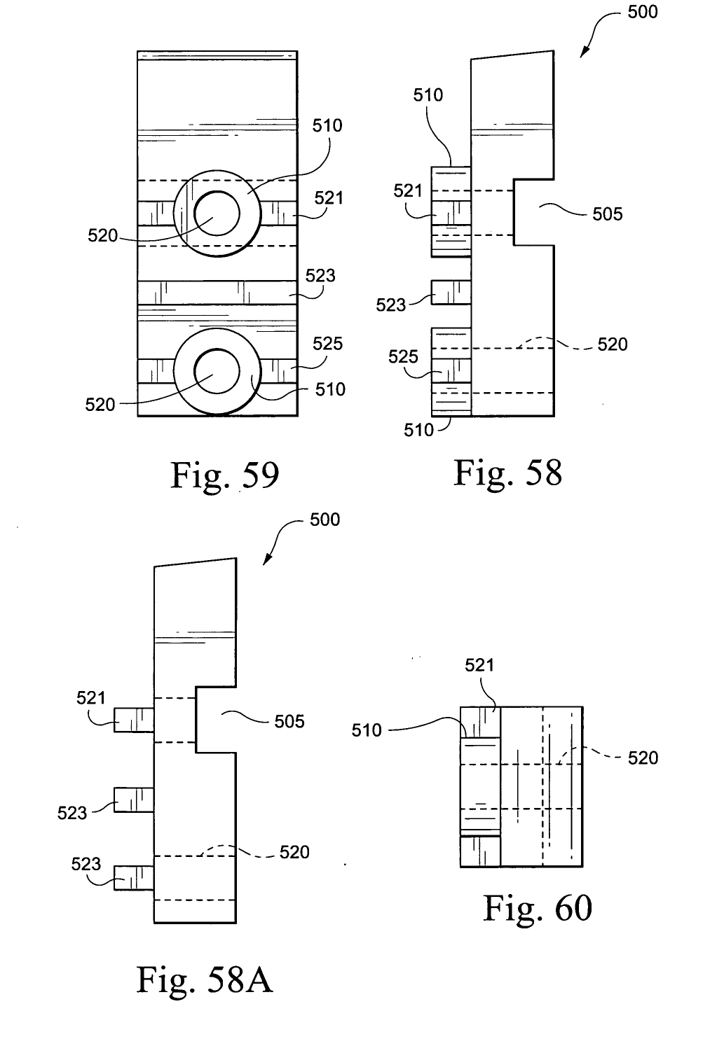

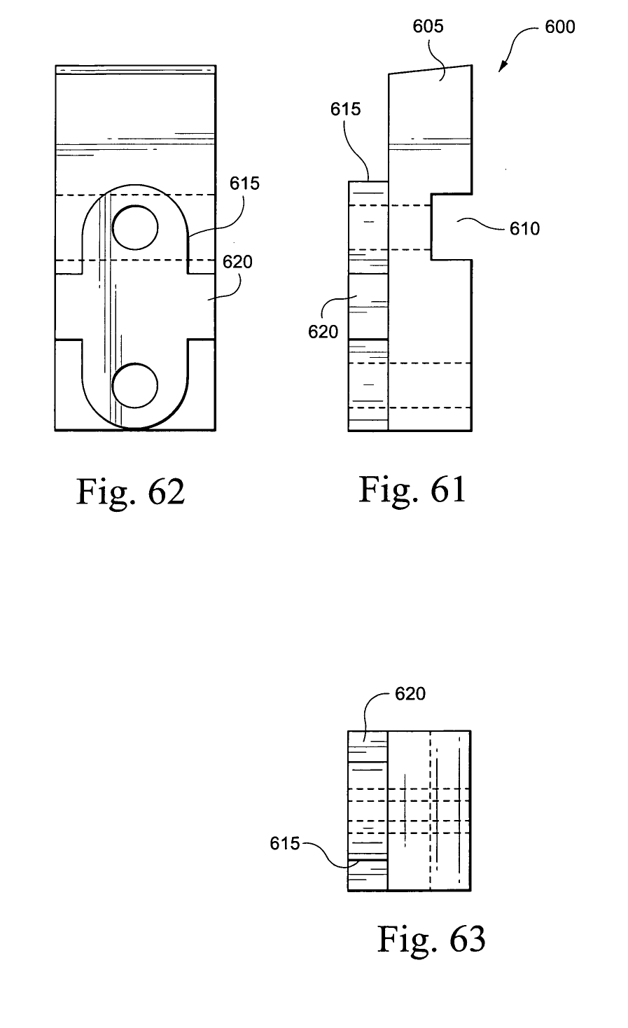

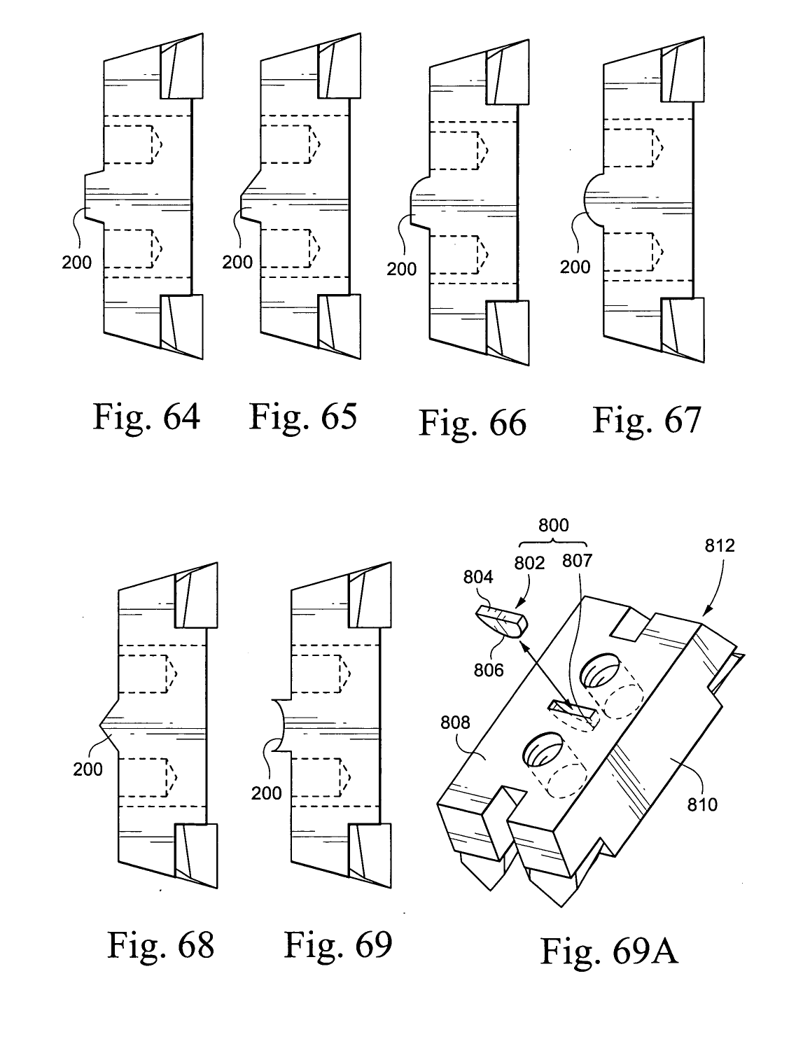

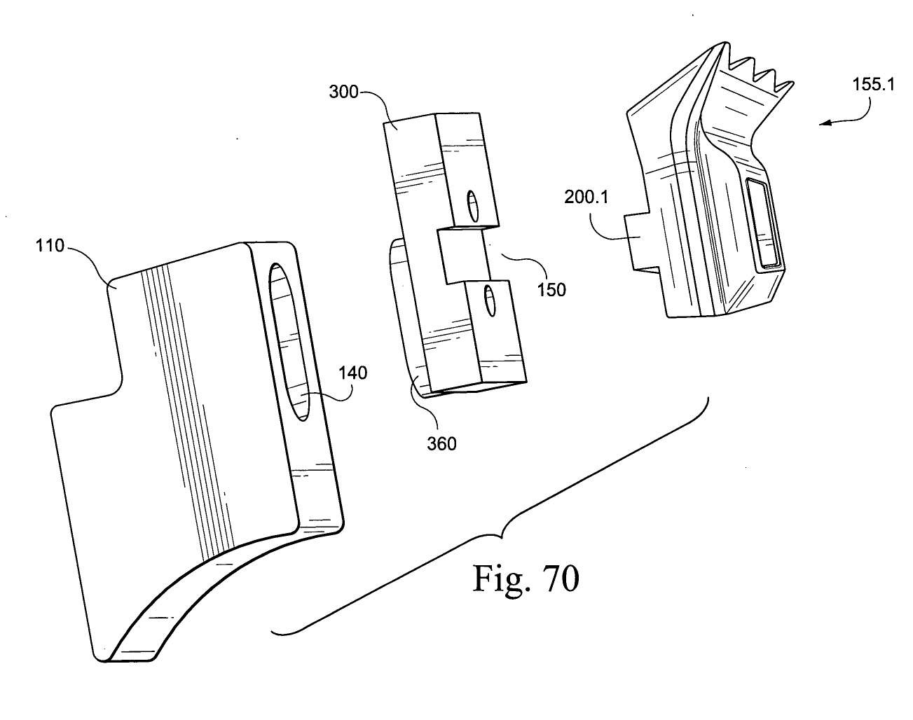

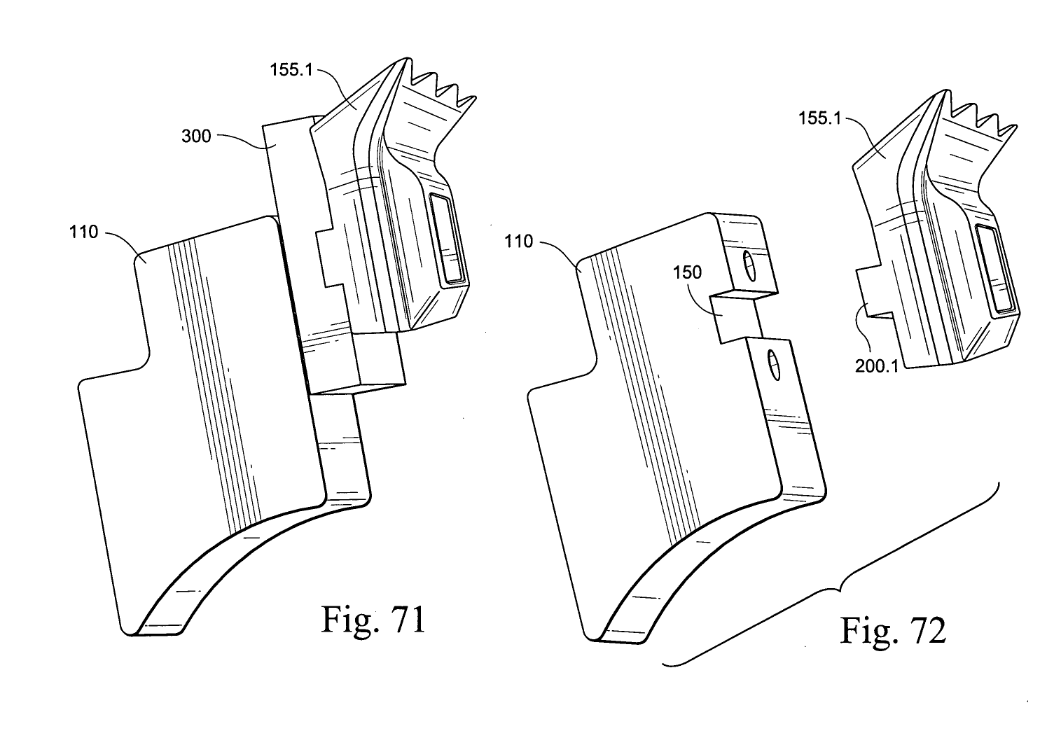

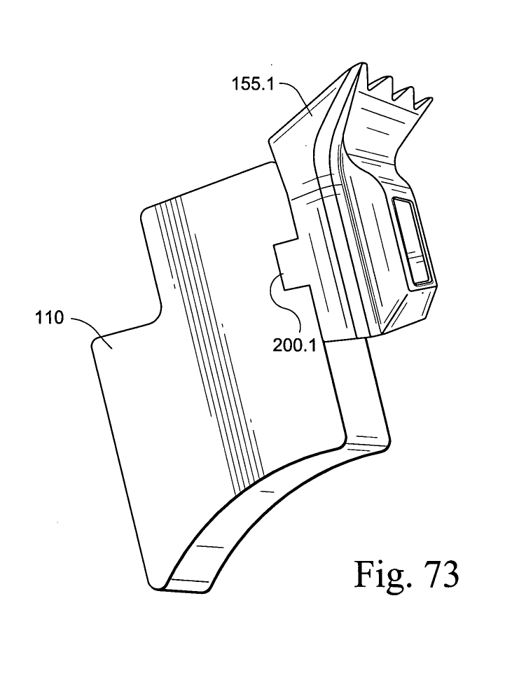

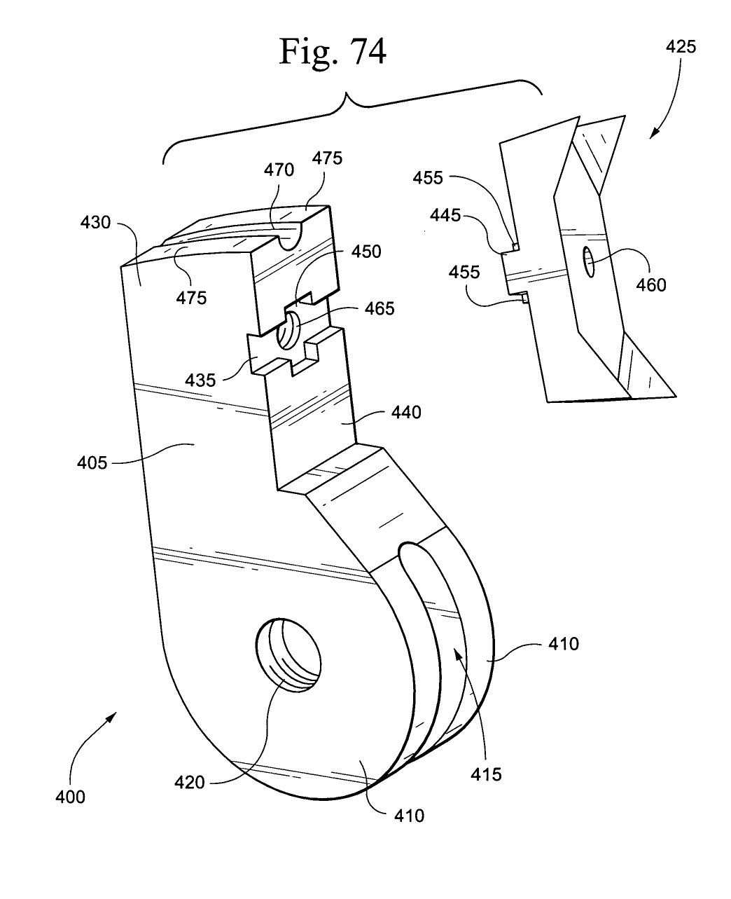

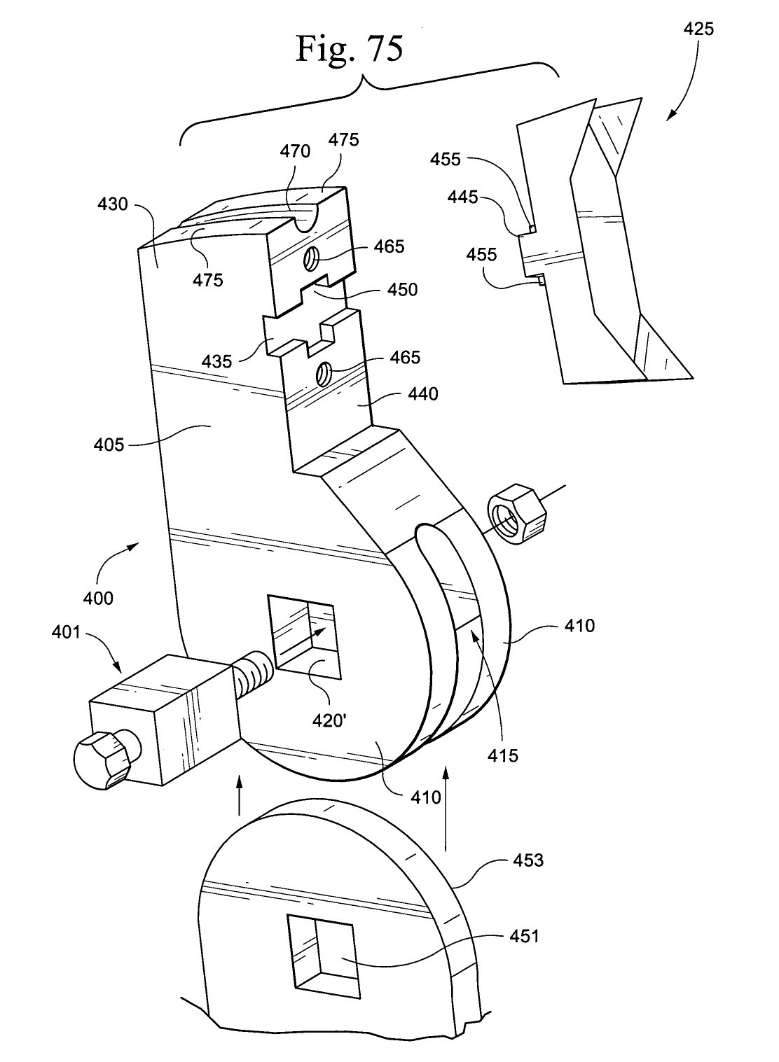

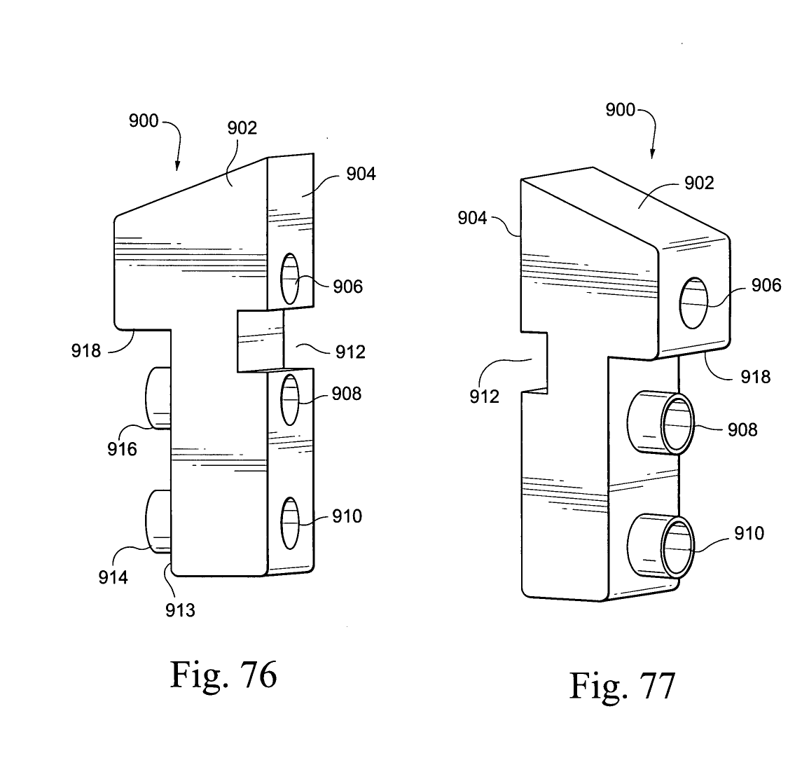

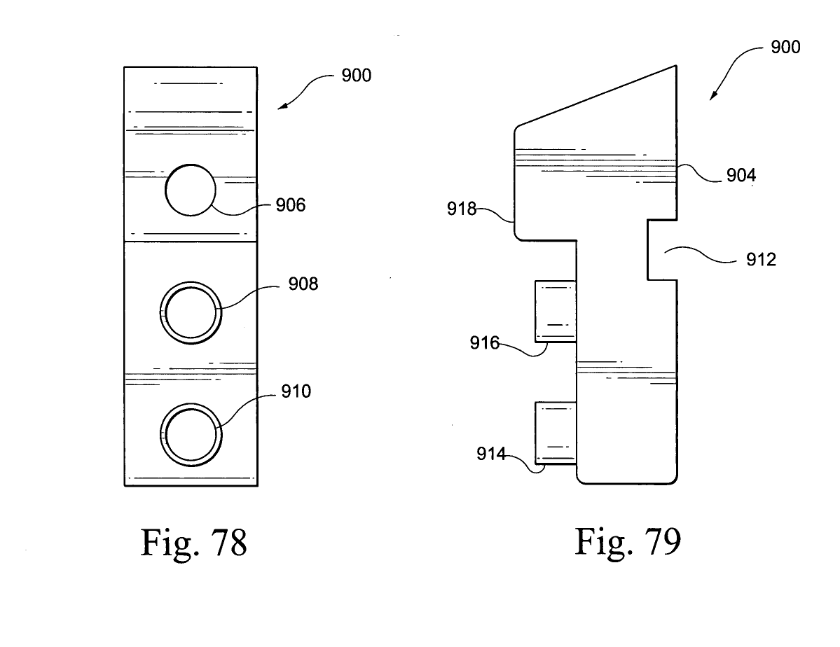

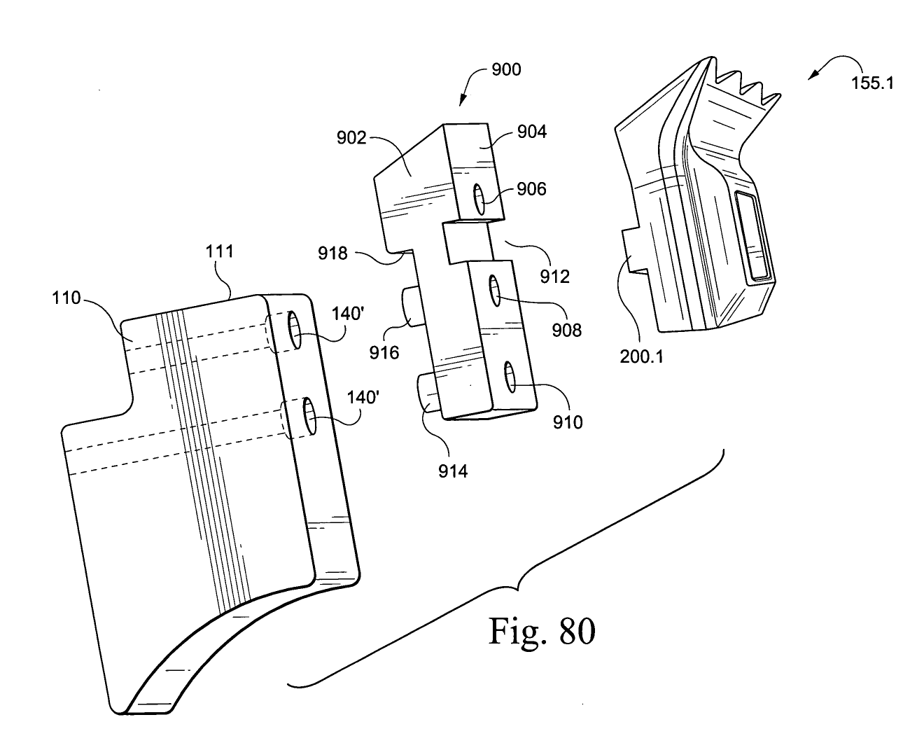

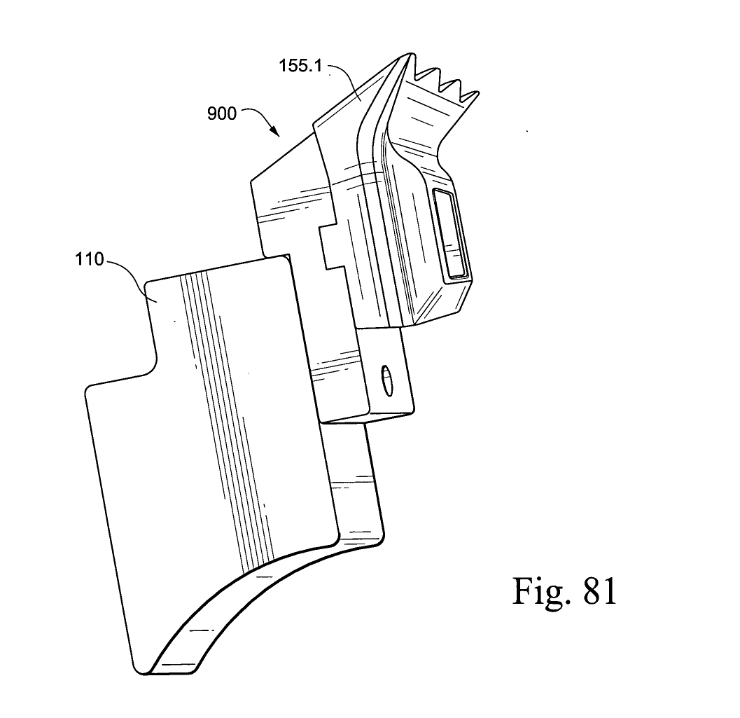

FIG. 33A is a top view thereof;

FIG. 34 is a side view of a cutter according to yet another embodiment of the present invention;

FIG. 35 is a right side view thereof;

FIG. 36 is a left side view thereof;

FIG. 37 is a top view thereof;

FIG. 37.1 is a perspective view of a cutter element according to an embodiment of the present invention;

FIG. 37.2 is a reverse perspective view thereof;

FIG. 37.3 is a front view thereof;

FIG. 37.4 is a rear view thereof;

FIG. 37.5 is a top view thereof;

FIGS. 37.6 and 37.7 are bottom and side views thereof, respectively;

FIG. 37.8 is a top view of a tooth according to an embodiment of the present invention;

FIG. 37.9 is a perspective view of a cutter element according to an embodiment of the present invention;

FIG. 37.10 is a reverse perspective view;

FIG. 37.11 is a front view thereof;

FIG. 37.12 is a rear view thereof;

FIG. 37.13 is a top/bottom view thereof;

FIG. 37.14 is a left side view thereof;

FIG. 37.15 of a perspective view of a cutter element according to an embodiment of the present invention;

FIG. 37.16 is a front view thereof;

FIG. 37.17 is a rear view thereof;

FIG. 37.18 is a side view thereof;

FIG. 37.19 is bottom view thereof;

FIG. 37.20 is a cross section along line 37.20-37.20 of FIG. 37.19;

FIG. 37.21 is a side view of a drum having a cutter element provided thereto according to an embodiment of the present invention;

FIG. 37.22 is an enlarged detail view of a portion of FIG. 37.21;

FIG. 37.23 is a side view of the drum and cutter element shown in FIG. 37.21;

FIG. 37.24 of a perspective view of a cutter element according to an embodiment of the present invention;

FIG. 37.25 is a front view thereof;

FIG. 37.26 is a rear view thereof;

FIG. 37.27 is a side view thereof;

FIG. 37.28 is bottom view thereof;

FIG. 37.29 is a cross section along line 37.29-37.29 of FIG. 37.28;

FIG. 37.30 is a perspective view of a cutter element according to another embodiment of the present invention;

FIG. 37.31 is a perspective view of a cutter element according to another embodiment of the present invention;

FIG. 37.32 is a perspective view of a cutter element according to another embodiment of the present invention;

FIG. 37.33 is a perspective view of a cutter element according to another embodiment of the present invention;

FIG. 37.34 of a perspective view of a cutter element according to another embodiment of the present invention;

FIG. 37.35 is a front view thereof;

FIG. 37.36 is a rear view thereof;

FIG. 37.37 is a side view thereof;

FIG. 37.38 is a top/bottom view thereof;

FIG. 37.39 is a cross section along line 37.39-37.39 of FIG. 37.38;

FIG. 37.40 of a perspective view of a cutter element according to another embodiment of the present invention;

FIG. 37.41 is a front view thereof;

FIG. 37.42 is a rear view thereof;

FIG. 37.43 is a side view thereof;

FIG. 37.44 is bottom view thereof;

FIG. 37.45 is a cross section along line 37.45-37.45 of FIG. 37.44;

FIG. 37.46 is another perspective view thereof;

FIG. 38 is a side view of a holder according to yet another embodiment of the present invention;

FIG. 39 is a right side view thereof;

FIG. 40 is a top view thereof;

FIG. 41 is a side view of a holder according to still another embodiment of the present invention;

FIG. 42 is a right side view thereof;

FIG. 43 is a top view thereof;

FIG. 44 illustrates still another cutter element according to an embodiment of the present invention;

FIG. 45 is a right side view thereof;

FIG. 46 is a left side view thereof;

FIG. 47 is a top view thereof;

FIG. 44A illustrates still another cutter element according to an embodiment of the present invention;

FIG. 45A is a right side view thereof;

FIG. 46A is a left side view thereof;

FIG. 47A is a top view thereof;

FIG. 48 illustrates still another cutter element according to an embodiment of the present invention;

FIG. 49 is a right side view thereof;

FIG. 50 is a left side view thereof;

FIG. 51 is a top view thereof;

FIG. 52 illustrates an adapter according to an embodiment of the present invention;

FIG. 53 is a left side view thereof;

FIG. 54 is a top view thereof;

FIG. 55 illustrates an adapter according to another embodiment of the present invention;

FIG. 56 is a left side view thereof;

FIG. 57 is a top view thereof;

FIG. 58 illustrates yet another adapter according to an embodiment of the present invention;

FIG. 59 is a left side view thereof;

FIG. 60 is a top view thereof;

FIG. 58A illustrates an adapter according to another embodiment of the present invention;

FIG. 61 illustrates still another adapter according to an embodiment of the present invention;

FIG. 62 is a left side view thereof;

FIG. 63 is a top view thereof;

FIGS. 64-69A illustrate side views of a cutter element similar to that shown in FIG. 30, but which show further embodiments of cross bars according to embodiments of the present invention;

FIG. 70 is an exploded view of a holder, adapter and cutter element according to an embodiment of the present invention;

FIG. 71 is an assembled view thereof;

FIG. 72 is an exploded view of a holder element and cutter element according to an embodiment of the present invention;

FIG. 73 is an assembled view thereof;

FIG. 74 is an exploded view of a holder and cutter element according to another embodiment of the present invention;

FIG. 75 is an exploded view of a holder and cutter element according to another embodiment of the present invention;

FIG. 76 is a front perspective view of an adapter according to another embodiment of the present invention;

FIG. 77 is a reverse perspective view thereof;

FIG. 78 is a rear view thereof;

FIG. 79 is a right side view thereof, with the left side view being a mirror image thereof;

FIG. 80 is an exploded perspective view of a tooth assembly according to an embodiment of the present invention; and

FIG. 81 is an assembled view of the tooth assembly shown in FIG. 80.

### DETAILED DESCRIPTION OF ILLUSTRATED EMBODIMENTS

The following description is provided in relation to several embodiments which may share common characteristics and features. It is to be understood that one or more features of any one embodiment may be combinable with one or more features of the other embodiments. In addition, any single feature or combination of features in any of the embodiments may constitute additional embodiments.

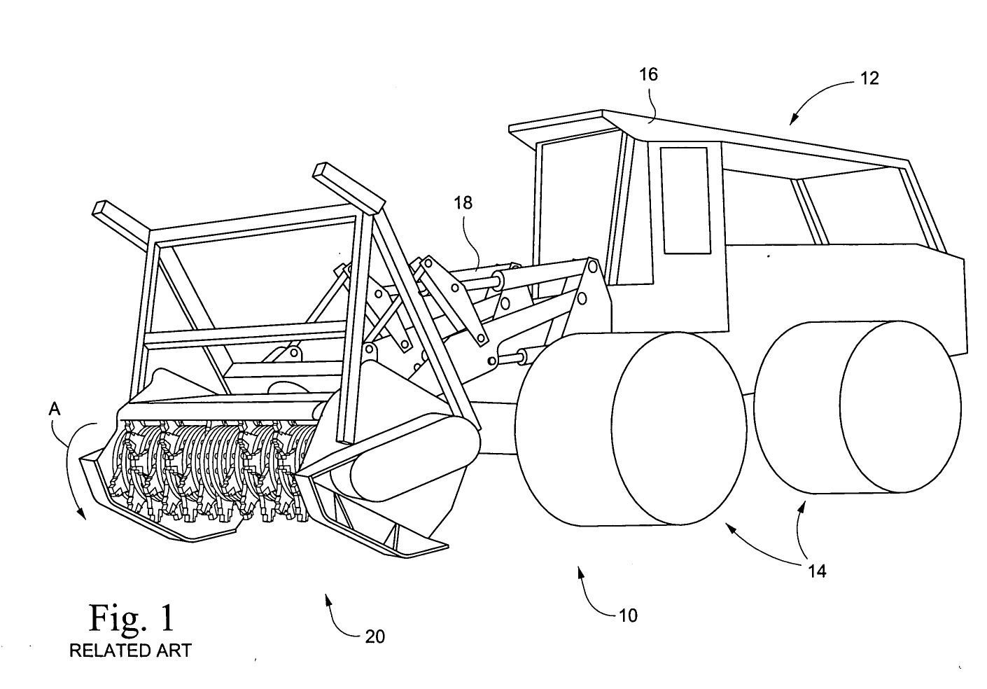

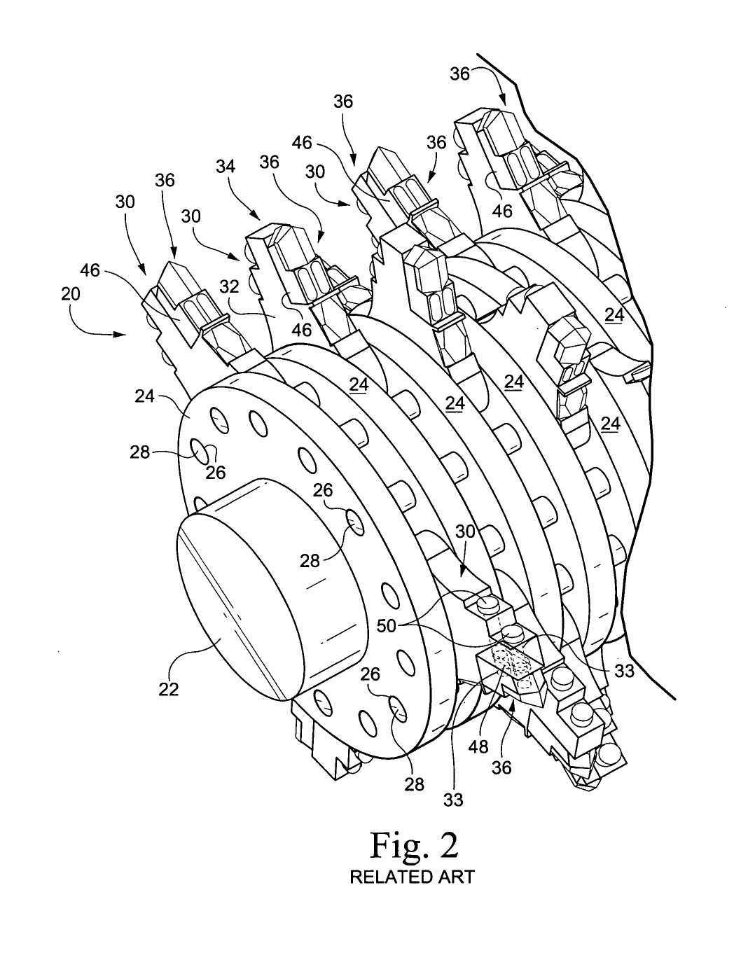

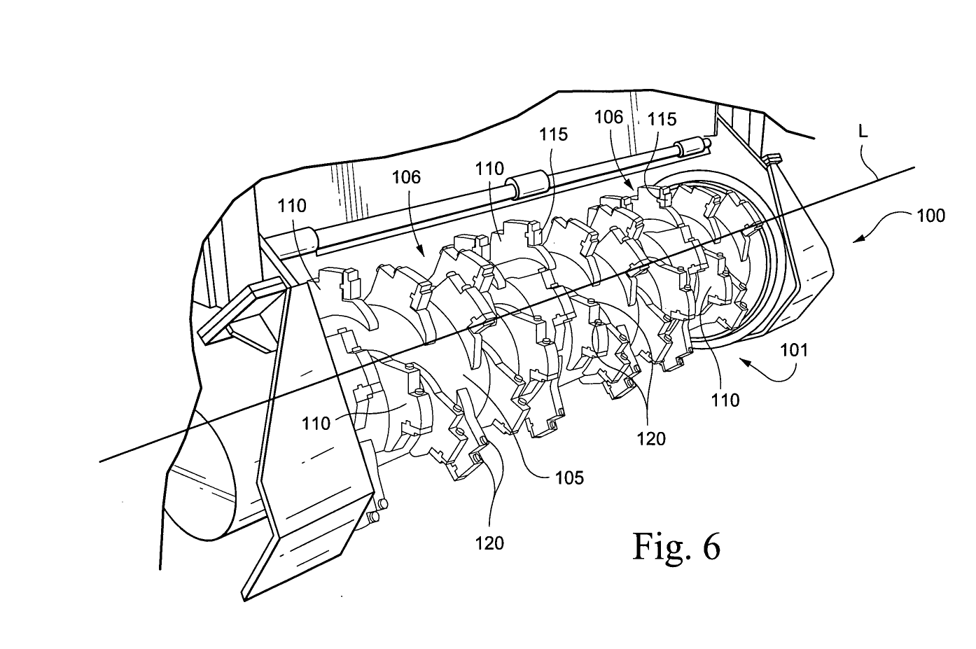

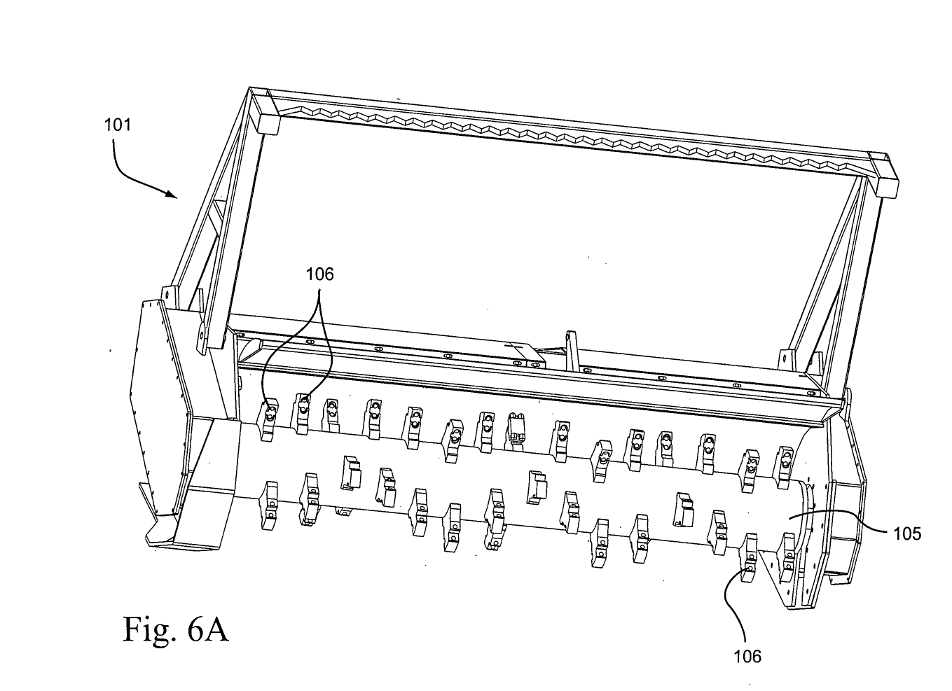

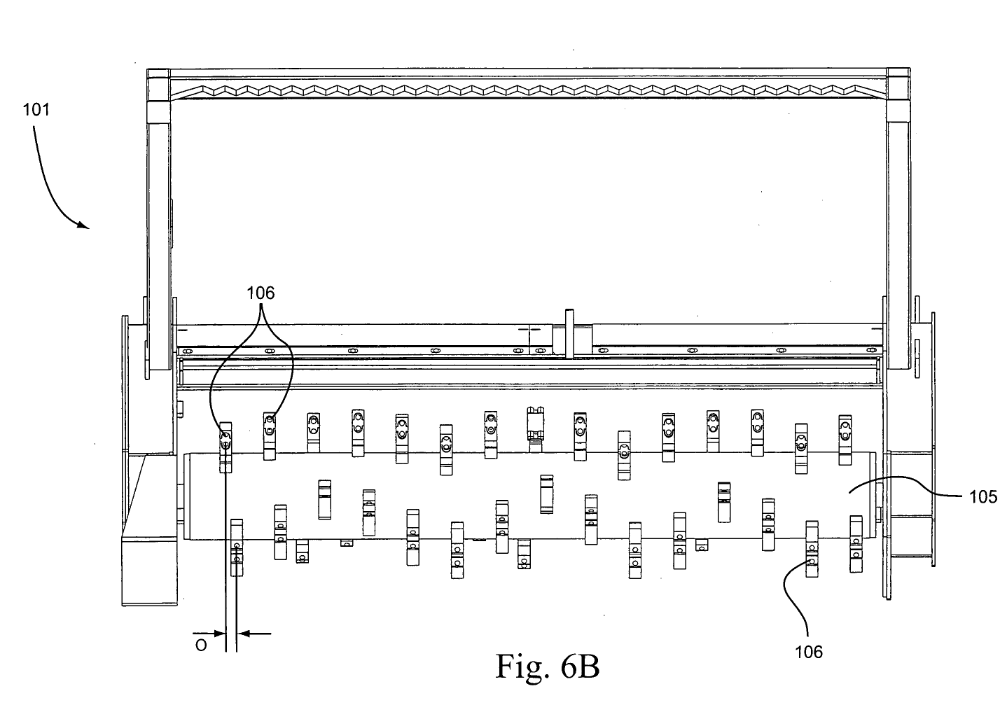

FIG. 6 illustrates a portion of a mulcher apparatus 100 according to one embodiment of the present invention. In this specification, the term mulcher apparatus is intended to be inclusive of grinders, wood chippers, tub grinders and horizontal grinders, etc. The mulcher apparatus 100 includes a tractor, for example, as shown in relation to FIG. 1. The mulcher apparatus 100 includes a mulching unit 101 that includes a rotor 105, e.g., in the form of a solid or hollow cylindrical drum, and a plurality of tooth assemblies 106 each having a holder 110 and a cutter element 115. Each of the holders 110 is mounted to the rotor 105, e.g., by welding. However, the holders 110 may be attached to the rotor 105 in a manner which is similar to that shown and described in relation to FIG. 2. Each holder 110 is structured to support the cutter element 115 along the bottom and/or rear walls thereof, e.g., the holder forms a step like configuration where the cutter element 115 may be supported along the rear and/or bottom surfaces thereof. The holder 110 and the cutter element 115 may be held together using a bolt, the head portions 120 of which are shown in FIG. 6, so that the cutter elements 115 can be easily removed and replaced.

FIG. 6 illustrates that the number of cutter elements 115 that engage the intended target is maintained at a minimum, for a maximum number of tooth assemblies 106. For example, although the rotor 105 includes about 36 or 66 tooth assemblies 106, for two sizes of mulchers, respectively, only from about 2 to 4 cutter elements 115 contact the target at the same time along cutting line L, thus decreasing the drain on the overall system and increasing average power available for the next series of cutting impacts between the tooth assemblies 106 and the target. This results in incremental chipping or nibbling a target by sequential contact, rather than simultaneous contact between a row of cutting elements and the target. Preferably, an equal number of cutting elements on opposite sides of the axial centerline of the drum 105 contact the target. Even more preferably, the simultaneous contact cutting elements are spaced approximately the same distance from and on opposite sides of the axial centerline, to help maintain balance.

Moreover, in one embodiment, for a rotating drum 105 having a length of 5 foot, there would be approximately 30-60 tooth assemblies 106, preferably about 45 tooth assemblies 106, only 2-4 of which contact the target at the same time since they are arguably offset as positioned on the drum. Stated differently, the drum 105 includes about 8-10 tooth assemblies per foot of drum. This is achieved by a unique pattern in which the tooth assemblies 106 are positioned on drum 105. For example, each drum includes 3-5 rows, preferably 4 rows of tooth assemblies 106.

FIG. 6A is a perspective view of a mulching unit 101 in which drum is provided with several rows of tooth assemblies 106, 15 per row in this example, which means that the drum 105 includes 60 total tooth assemblies if 4 rows are utilized. Two complete rows are visible in FIG. 6A while a third row is partially visible and a fourth row is not visible. FIG. 6A shows the holders without the cutting element, although one holder is shown with an exemplary cutting element or tooth. The pattern defined by the tooth assemblies in each row can be described as undulating, e.g., “W” or “M” shaped. The pattern of each row is designed to avoid more than a certain number of teeth from contacting the target at the same time, as described above, e.g., by positioning adjacent teeth in a row such that there is only a small degree of overlap of the holders. Further the teeth in adjacent rows have very little if any overlap, as shown in FIG. 6A. Moreover, as shown in FIG. 6B, the teeth in adjacent rows, e.g., the first tooth in a first row and the first tooth in a second row, are offset a distance O to ensure even and smooth cutting of the target.

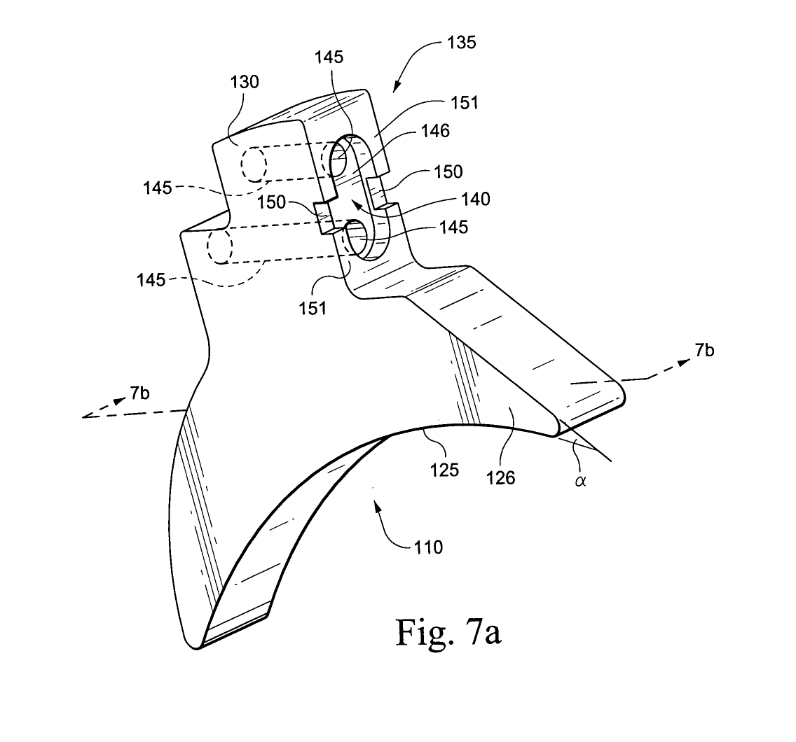

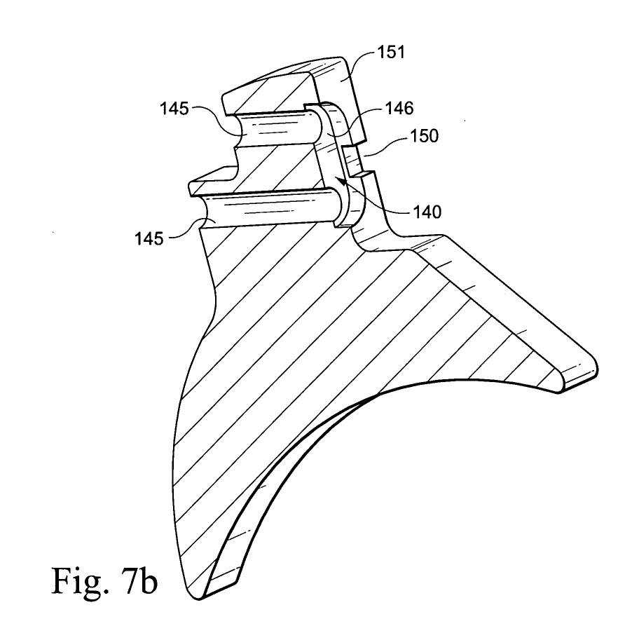

Also, the base portion of the holder 110 is gently angled with respect to the rotor 105, e.g., the angle α is between about 5° and 60°, preferably 30°. See FIG. 7a. This structure minimizes the force, if any, created between the base portion of the holder 110 and the target, thereby minimizing damage to the base portion and obviating the need to provide a secondary cutting or deflecting element to the body portion. This structure also helps maintain the average power at a higher level in part because a leading edge 126 of the base portion simply slides past any debris and the target with less direct impact.

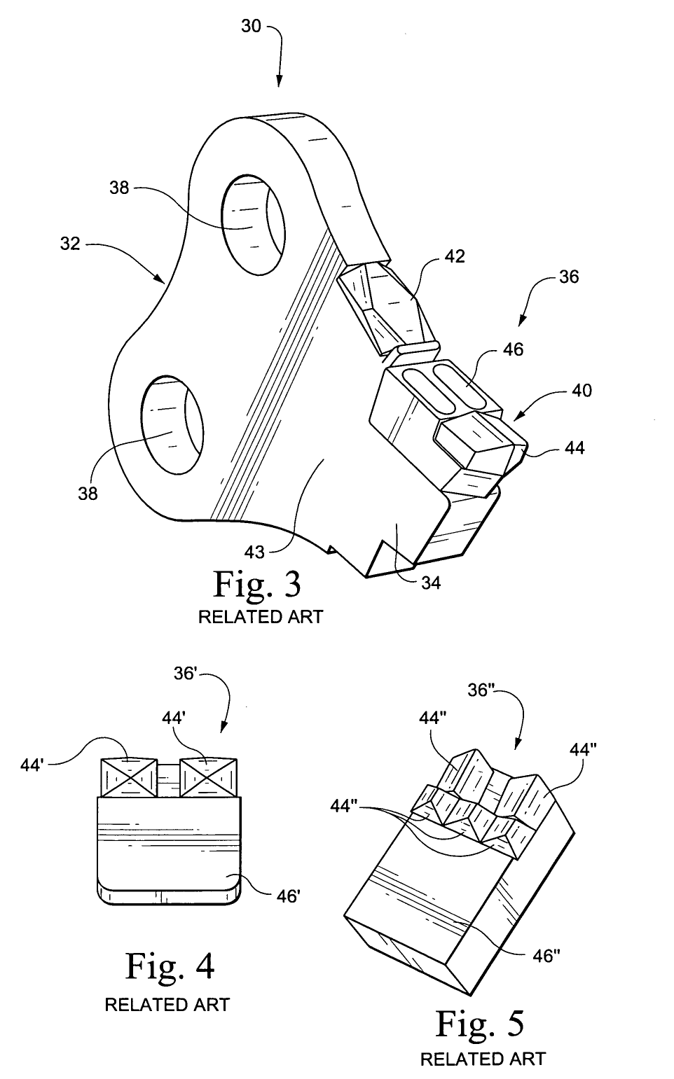

FIG. 7a illustrates in perspective a first embodiment of a holder 110 according to the present invention. The holder 110 can be made of machined, forged or cast iron materials, although it is preferred that the holder be machined or cut from a steel plate. The holder 110 includes a base portion 125 that is welded to or otherwise affixed to the rotor 105. The holder 110 includes a head portion 130 positioned opposite to the base portion 125. The head portion 130 includes a cutter element engagement portion 135 which in this embodiment includes an oval shaped countersunk recess or aperture 140 which is similar to that described in relation to related art FIGS. 1-5. The aperture 140 is sunken into the surface of the cutter element engagement portion 135. At least one and preferably a pair of through holes 145 are provided on the inside surface 146 of the aperture 140. A pair of notch portions 150 can be machined, cut or otherwise provided to the side wall portions 151 defining the sides of the aperture 140. FIG. 7b is a cross-sectional view of FIG. 7a.

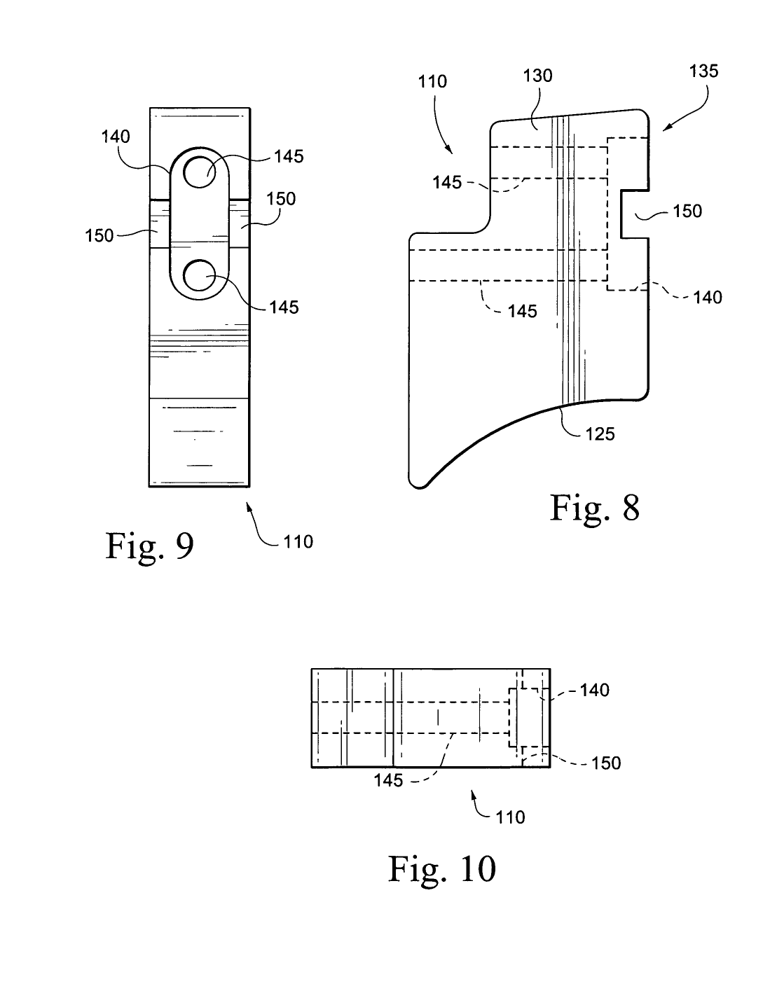

FIGS. 8-10 illustrate side, front and top views of a holder 110, similar to that shown in FIG. 7a. Moreover, the leading and trailing ends of the holder in FIGS. 8-10 has been truncated, to reduce weight and material cost.

The holder in FIG. 7a is somewhat similar to a related art holder, but has been adapted to include, among other things, notch portions 150, the significance of which will be described below in relation to various cutter elements.

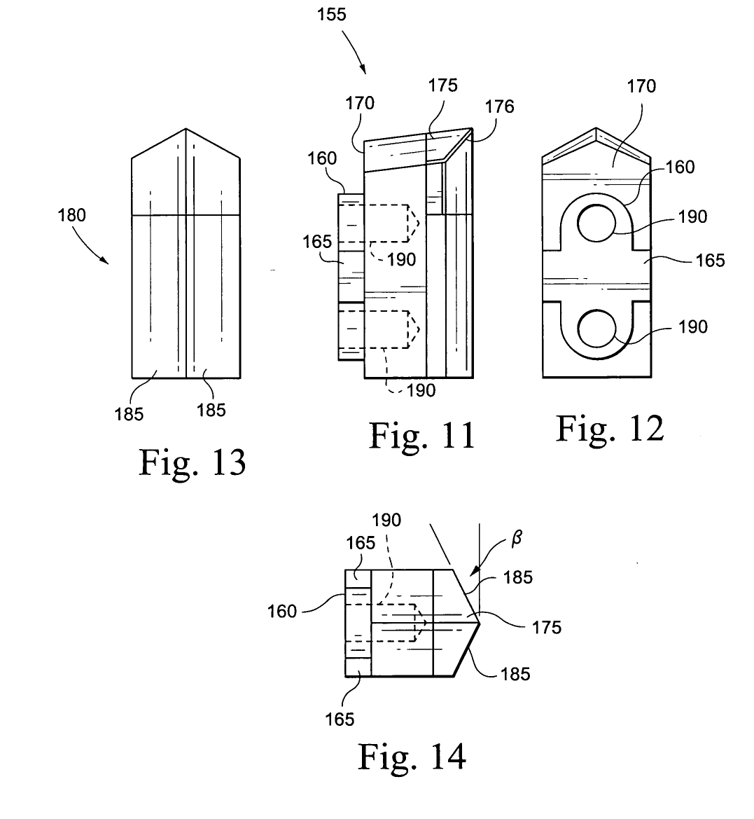

FIGS. 11-22c illustrate various embodiments of cutter elements which may be used in conjunction with the holder 110 shown in FIGS. 7a-10.

FIGS. 11-14 illustrate a cutter element 155 including a protruding oval or hour-glass shaped shroud 160 that is complimentary to the shape of the aperture 140 in FIG. 7a. FIGS. 11, 12 and 14 show a cross bar 165 that is intended to interlock with the notch portions 150 provided in side walls 151 of the holder 110 shown in FIG. 7a. The cross bar 165 may protrude from a rear surface 170 an amount which is equal to the amount the shroud 160 protrudes from the rear surface 170. However, the depth of the cross bar 165 may be less than the depth of the shroud 160, in which case the depth of the notch portions 150 and the depth of the aperture 140 would be different, as shown in FIG. 7a. A tip portion 175 may include a carbide coating 176, to increase strength or durability. In addition, a main body portion 180 may include angled front wall portions 185 to help laterally disperse debris as it is cut. FIG. 14 shows the angle β at which the front wall portions 185 converge or meet, e.g., P is about 15-45°, or preferably 30°, from vertical. In this example, the angles of the front wall portions 185 and the angles of the converging walls of the tip portion 175 are the same, although they could be different. The cutter element 155 is provided with one and preferably a pair of threaded bores 190, which in this case are blind bores.

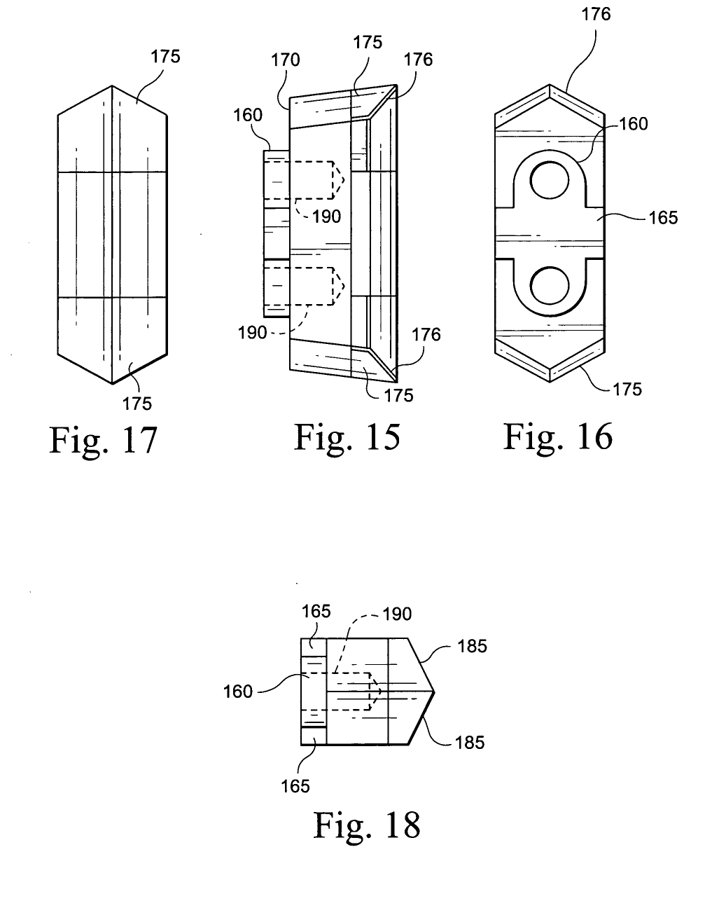

FIGS. 15-18 illustrate another embodiment of a cutter element according to the present invention that may be used with the holder 110 shown in FIGS. 7a-10.

The embodiment of FIGS. 15-18 is similar to the embodiment of FIGS. 11-14 except that the embodiment of FIGS. 15-18 includes a pair of opposite tip portions 175. Accordingly, when one tip portion 175 has been spent or damaged, the cutter element can be removed and rotated 180°, thereby providing the fresh tip portion to the targeted cutting or mulching surface. Although the embodiment of FIGS. 15-18 provides for two tip portions 175, it is also contemplated that three or more tip portions may also be provided. For example, the cutter element may assume the configuration of a triangle with cutting elements provided at the apices.

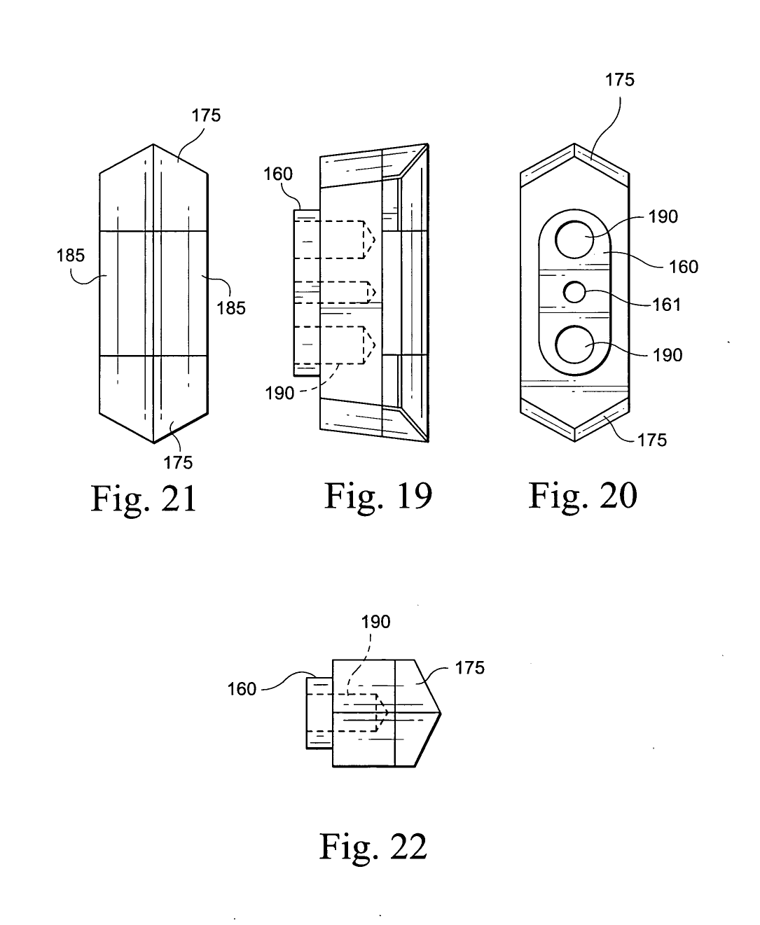

The embodiment of FIGS. 19-22 is similar to the embodiments of FIGS. 15-18, except that the embodiment of FIGS. 19-22 is not provided with a cross bar. In this embodiment, a shroud 160 engages with the aperture 140 in FIG. 7a, and the notch portions 150 in FIG. 7a are not utilized. FIG. 20 shows an aperture 161, the purpose of which is to provide an additional or alternative means by which the shroud may be fastened to the main body, in the event the shroud is not formed in a single piece with the main body.

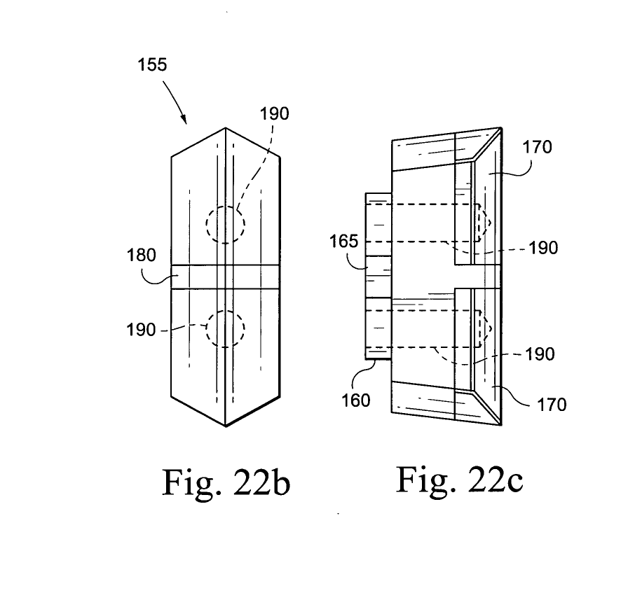

FIGS. 22b and 22c illustrate an embodiment of the invention in which a cutter element 155 includes a main body 180 and a shroud 160. The main body and shroud include one and preferably two bores, e.g., blind bores 190. The bores 190 extend into each of the tip portions 170. Accordingly, rather than replacing the entire cutter element 155, only the tip portions 170 need be replaced when spent.

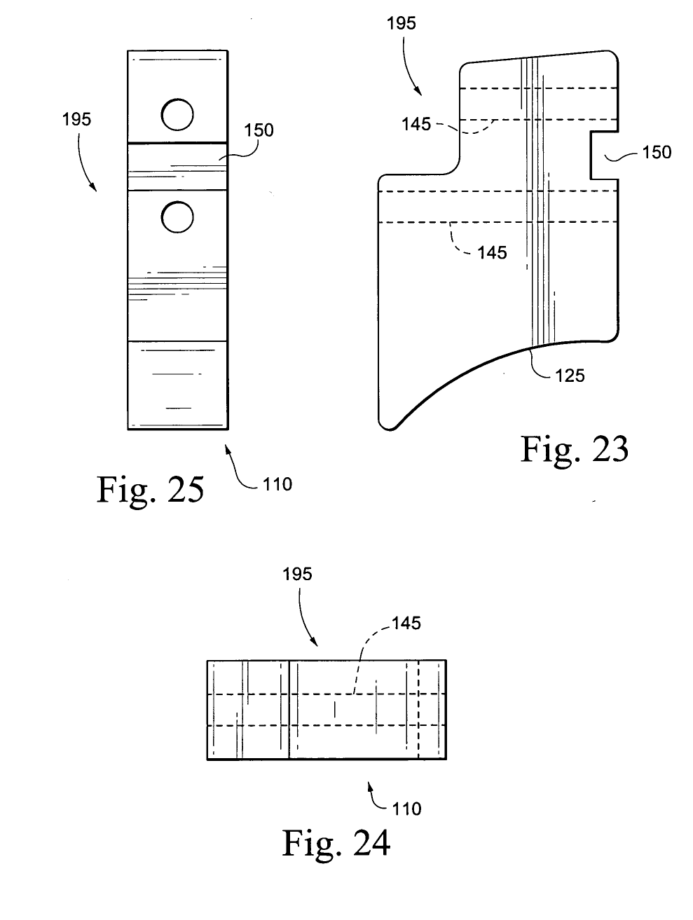

FIGS. 23-25 illustrate yet another embodiment of a holder 195 according to the present invention. The holder 195 of FIGS. 23-25 differs from the holder 110 shown in FIGS. 7a-10 in that the aperture 140 in FIG. 7a is not provided in the embodiment of FIGS. 23-25. Instead, the embodiment of FIGS. 23-25 only includes a notch portion 150 along with a pair of bores 145 offset on each side of the notch portion 150. The notch portions 150 shown in FIGS. 7a and 23 can be formed by machining, cutting or routing in a simple one step procedure. With the embodiment of FIGS. 23-25, the aperture 140 is not provided, which saves in assembly cost and manufacturing expense.

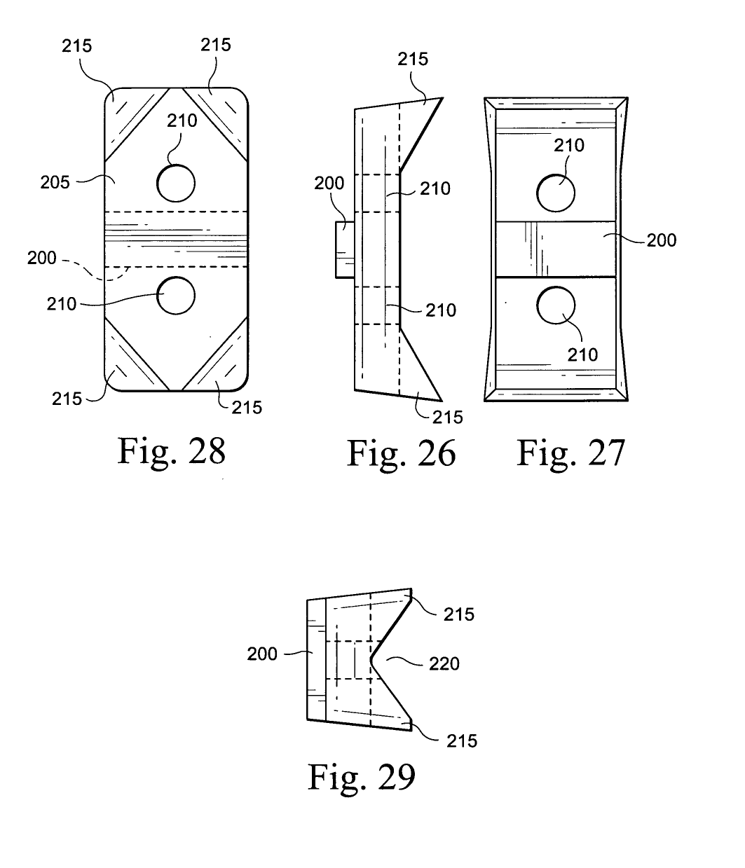

FIGS. 26-37.31 illustrate embodiments of cutter elements having cross bars 200 that are usable with the holders 110, 195 of either FIGS. 7a-10 or FIGS. 23-25. In the embodiments of FIGS. 26-37.31, the various cutter elements are provided with a cross bar 200 which is intended to interface with the notch portions 150 of FIGS. 7a-10 or 23-25.

The embodiment of FIGS. 26-29 includes a main body portion 205 provided with a pair of bores, e.g., through bores 210. Each corner portion of the main body 205 is provided with an angled tab portion 215 acting as the cutter element. The angled tab portions 215 are angled in the range of 15-45° (preferably 30°) from the vertical plane in FIG. 26, and the space 220 in FIG. 29 defines an angle of about 100-160° (preferably 120°) as shown, for example in FIGS. 26 and 29. Each angled tab portion 215 may be coated with a carbide material, thereby enhancing strength and/or durability. As shown in FIG. 29, a space 220 may be provided between the tip portions of the angled tab portions 215. The space 220 allows for debris to pass therebetween, thereby adding less load to the motor and thereby maintaining power at a more constant level.

In the embodiment of FIGS. 30-33, the main body portion 205 has the general shape of an H, as best shown in FIGS. 31 and 32, including a cross portion and two upright portions, all combining to form the “H” shape. Each tip portion 175 is provided with a notch 177 to accommodate a carbide tip insert 178 which can be welded to or otherwise affixed to the main body portion 205. An aperture 220 is provided between adjacent ones of the tip portions 175 to allow debris to flow therethrough, as described above in relation to the embodiment of FIGS. 26-29.

The embodiment of FIGS. 30A-33A is similar to the embodiment of FIGS. 30-33, where like reference numbers denote like parts. However, there are several main differences between the embodiments. First, aperture 220′ includes a base wall portion that is inclined so as to guide debris over the top edge of the tooth's holder. See, e.g., holder 135 in FIGS. 8-10. Aperture 220′ may be provided with a carbide insert 207 to better counteract the wear and tear associated with passing debris. Carbide insert 207 may include a tip portion 209 that extends slightly above aperture 220′ to ensure that debris is channeled and guided above holder 135 (FIG. 8). Second, main body portion 205 includes angled edges 203 to decrease friction and/or interaction with passing debris. This structure results in decreased material usage and weight as well. For similar reasons, the front and/or top portions 178a, 178b of tip inserts 178 are angled. Top portions 178b converge with one another and one angled at about 0-10° relative to one another.

The cutter element embodiment of FIGS. 34-37 is similar to the embodiment of FIGS. 15-18, but includes only a cross bar 200 rather than the cross bar 165 and a shroud 160, as in the embodiment of FIGS. 15-18.

FIGS. 37.1-37.7 illustrate a cutter element 155.1 having a main body 205.1 provided with one or more bores 210.1, e.g., threaded blind bores which extend from a rear side 212.1 of the main body 205.1 towards a front side 214.1 of the main body 205.1.

Cutter element 155.1 includes a cutting portion 175.1 having a cutting edge, e.g., in the form of a serrated edge defined by a plurality of angled portions 179.1 oriented towards the cutting direction D, as seen in FIGS. 37.2 and 37.3. Angled portions 179.1 form peaks 180.1 and valleys 180.2 as best seen in FIG. 37.6.

The peaks 180.1 allow for point contact as opposed to linear contact which helps to step-wise chip away at and/or fracture the intended target. At the same time, valleys 180.2 allow for debris to pass easily through the tooth, thus minimizing the power loss to the rotor, and/or the required power to rotate the rotor. Cutting portion 175.1 may also take the form of a straight edge, or part serrated edge and part straight edge.

As seen in FIGS. 37.1 and 37.5, a top surface 181.1 of cutting portion 175.1 includes one or more grooves 183.1 to allow easy passage of the cutting edge through debris. Cutting portion 175.1, e.g., grooves 183.1, is dimensioned to define or gauge the “depth of cut” of the material to be cut. In particular, as seen in FIG. 37.7, the cutting portion 175.1 is somewhat wedge shaped in that the leading edge is higher than the trailing edge of the top surface. This configuration allows the tooth to chip or peel off small bits which helps to maintain speed of rotation of the drum and decreases horsepower requirements.

As seen in FIG. 37.4, the angle X between adjacent walls of the grooves is about 125°-175°, or about 150°. The grooves 183.1 may extend further towards the rear side 212.1 of the cutter element, as shown in FIG. 37.8. The top surface 181.1 is generally curved from the cutting edge 177.1 to the rear side of the main body, as can be seen in FIG. 37.7. The tip of the cutting edge is raised in comparison to the rear side of the curved surface 183.1, e.g., by 5-30 mm. While FIG. 37.7 and other figures described herein show the top surface 181.1 to be curved or radiused, it could also be linear or curvilinear, and it may also include relief portions. The tip is higher than the heel, e.g., relative to the rotation axis of the drum, to reduce drag on the trailing portion of the tooth. The forward most portion of each groove 183.1 may include a tapered or recessed portion 185.1 which allows even further efficiencies by allowing the cutter element to glide past debris. The recessed portion 185.1 is thinner than the remaining portions of the grooves.

As shown in FIG. 37.7, the front tip of the cutting edge 177.1 extends forwardly of a front surface of the main body by a distance A, e.g., about 5-20 mm, such that brush contacts the cutting edge before contacting the main body 205.1. Further, the cutting edge is oriented such that it is generally parallel to the target cutting surface, i.e., parallel to the cutting direction D to allow more aggressive slicing action with less horsepower. The front side 181.1 of cutting portion 175.1 forms an angle B with horizontal of about 30°-70°, or about 45°.

Main body 205.1 may have a truncated pyramid shape having lateral walls 216.1, an upper wall 218.1 and a lower wall 220.1 that are angled to allow the main body 205.1 to deflect debris. The upper wall 220.1 may help to define a U- or L-shaped channel 222.1 (FIG. 37.7) which together with the forwardly oriented cutting edge 177.1 defines a scoop type structure, to maximize ease of cutting and cutting depth. However, the truncated pyramid shape is not necessary, as the front side 214.1 of the main body 205.1 can be generally flat and blend with the cutting portion 175.1 without a scoop like configuration.

A seen in FIG. 37.7, the threaded bores 210.1 may extend into the main body 205.1 to a depth which reaches the truncated pyramid section. This provides for extra threaded length to ensure that the cutter element 155.1 is properly secured to the holder.

As seen in FIG. 37.3, the width W of the edge 177.1 is greater than the width w of the main body of the cutter element. For example, the edge width W may be at least about 5% or 5-70% (or about 50%) greater than the width of the main body 205.1. The edge 177.1 can also have the same width as the main body 205.1, or it can even be narrower, if desired.

As seen in FIGS. 37.1-37.7, cutter element 15.1 includes a cross bar 200.1 which is generally rectangular in shape. Cross bar 200.1 extends about the width of the main body 205.1, or slightly less, and is positioned between the threaded bores 210.1. A middle portion 224.1 of the cross bar may be slightly necked down to maximize the dimensions of the cross bar 200.1 while accommodating or the threaded bores 210.1.

Cutter element 155.1 is made of forged steel, but can also be machined or cast. The edge 177.1 can be integrally included, or it can be separately attached to either the cutter portion 175.1 of the main body 205.1.

The cutting edge 177.1 can be supplemented with one or more strengthening layers, such a carbide insert or layer or a tungsten carbide coating (spray-on). Carbide insert layer can be mechanically attached to the cutter body, e.g., by welding, gluing, or other attachment mechanisms.

In one example, a tungsten carbide layer can be sprayed on to the inner surface 190.1 and/or the top surface 181.1 of the cutting portion 175.1. The tungsten carbide can extend to the tips of the serrated edge and even cover the angled surfaces 179.1. In another example, a tungsten or tungsten carbide insert can be welded to the inner surface 190.1 and/or the top surface 181.1- or the insert can be positioned within a notch formed in the cutting portion 175.1. If strengthening layer is applied (e.g., welded) only on the inner surface 190.1, the cutting edge can be self sharpening since the parent steel material on the top surface 181.1 of the cutting portion 175.1 will wear away until reaching the carbide layer, at which point the wearing away will occur at a much slower pace yet the cutting edge will remain sharp.

FIGS. 37.9-37.14 and 46-51 illustrate a cutter element 155.2 which is similar to cutter element 155.1, but it includes two cutting portions 175.2, one provided at each end of the main body 205.2. When one cutting portion 175.2 is spent, the cutter element 155.2 can be removed from the holder and attached in the opposite orientation (turn 180°) to position the unspent cutting portion 175.2 in the operative position.

FIGS. 37.15-37.23 illustrate a cutter element 155.3 having a main body 205.3 provided with at least one bore 210.3 (FIGS. 37.17 and 37.20), e.g., threaded blind bores which extend from a rear side 212.3 of the main body 205.3 towards a front side 214.3 of the main body 205.3.

Cutter element 155.3 includes a cutting portion 175.3 having a cutting edge, e.g., in the form of a serrated edge defined by a plurality of angled portions 179.3 oriented towards the cutting direction D, as seen in FIG. 37.18. Angled portions 179.3 form peaks 180.3 and valleys 180.4 as best seen in FIG. 37.16.

The peaks 180.3 allow for point contact as opposed to linear contact which helps to step-wise chip away at and/or fracture the intended target. At the same time, valleys 180.4 allow for debris to pass easily through the tooth, thus minimizing the power loss to the rotor, and/or the required power to rotate the rotor. Cutting portion 175.3 may also take the form of a straight edge, or part serrated edge and part straight edge.

As seen in FIG. 37.22, a top surface 181.3 of cutting portion 175.3 includes one or more grooves 183.3 to gauge depth of cut material and to allow easy passage of the cutting edge through debris. As seen in FIG. 37.19, the angle X between adjacent walls of the grooves is about 90°-155°, 115-130°, or about 120°, with the middle serration having a depth of about 0.1-0.4 inches, e.g., about ¼ inch. The outer serrations extend at an angle of 110°-130°, or about 120°+5°. The grooves 183.3 may extend further towards the rear side 212.3 of the cutter element, as shown in FIG. 37.20. The top surface 181.3 is generally curved (e.g., a radius of curvature of about 2.5 to 3.5 mm, or about 3.5 mm) from the cutting edge 177.3 to the rear side of the main body, as can be seen in FIG. 37.20. Top surface 181.3 may also be linear or curvilinear, as described above. The tip of the cutting edge is raised in comparison to the rear side of the curved surface 183.3, e.g., by 5-30 mm. The forward most portion of each groove 183.3 may include a tapered or recessed portion 185.3 which allows even further efficiencies by allowing the cutter element to glide past debris. The recessed portion 185.3 is thinner than the remaining portions of the grooves.

As shown in FIG. 37.18, the front tip of the cutting edge 177.3 extends forwardly of a front surface of the main body by a distance A, e.g., at least a few millimeters or about 5-20 mm, such that brush contacts the cutting edge before contacting the main body 205.3. Further, the cutting edge is oriented such that it is generally parallel to the target cutting surface, i.e., parallel to the cutting direction D to allow more aggressive slicing action with less horsepower. The front side 181.3 of cutting portion 175.3 forms an angle B with horizontal of about 30°-70°, or about 45°.

Main body 205.3 may have a truncated pyramid shape having lateral walls 216.3, an upper wall 218.3 and a lower wall 220.3 that are angled to allow the main body 205.3 to deflect debris. The upper wall 220.3 may help to define a U- or L-shaped channel 222.3 (FIG. 37.18) which together with the forwardly oriented cutting edge 177.3 defines a scoop type structure, to maximize ease of cutting and cutting depth. However, the truncated pyramid shape is not necessary, as the front side 214.3 of the main body 205.3 can be generally flat and blend with the cutting portion 175.3 without a scoop like configuration.

A seen in FIG. 37.20, the threaded bores 210.3 may extend into the main body 205.3 to a depth which reaches the truncated pyramid section. This provides for extra threaded length to ensure that the cutter element 155.3 is properly secured to the holder.

As seen in FIG. 37.16, the width W of the edge 177.3 is greater than the width w of the main body of the cutter element. For example, the edge width W may be at least about 5% or 5-70% (or about 50%) greater than the width of the main body 205.3. Width W defines an effective cutting width of about 2-3 inches, e.g., about 2.5-2.7 inches, with a height H (FIG. 37.19) of about 1-3 inches, e.g., about 2 inches, measured from the mounting face 212.3 to the forward most tip. The edge 177.3 can also have the same width as the main body 205.3, or it can even be narrower, if desired.

As seen in FIGS. 37.15-37.20, cutter element 155.3 includes a cross bar 200.3 which is generally rectangular in shape. Cross bar 200.3 extends about the width of the main body 205.3, or slightly less, and is positioned between the threaded bores 210.3. A middle portion 224.3 of the cross bar may be slightly necked down to maximize the dimensions of the cross bar 200.3 while accommodating or the threaded bores 210.3.

Cutter element 155.3 is made of forged steel, but can also be machined or cast. The edge 177.3 can be integrally included, or it can be separately attached to either the cutter portion 175.3 of the main body 205.3.

The cutting edge 177.3 can be supplemented with one or more strengthening layers, such as a carbide, tungsten-carbide or tungsten insert, deposit or layer or a tungsten-carbide coating (e.g., diffused or spray-on). A tungsten-carbide insert layer can be mechanically attached to the cutter body, e.g., by welding, gluing, or other attachment mechanisms. The cutter element or portions thereof may also be case hardened, e.g., to Rockwell 60 hardness.

In one example, a tungsten carbide layer can be sprayed on to the inner surface 190.3 and/or the top surface 181.3 of the cutting portion 175.3. The tungsten carbide can extend to the tips of the serrated edge and even cover the angled surfaces 179.3. In another example, a tungsten or tungsten carbide insert can be welded to the inner surface (or top rake face) 190.3 and/or the top surface 181.3- or the insert can be positioned within a notch formed in the cutting portion 175.3. If strengthening layer is applied (e.g., welded) only on the inner surface 190.3, the cutting edge can be self sharpening since the parent steel material on the top surface 181.3 of the cutting portion 175.3 will wear away until reaching the carbide layer, at which point the wearing away will occur at a much slower pace yet the cutting edge will remain sharp.

FIGS. 37.21 and 37.23 show a drum 105 including one or more cutter elements 155.3, mounted to drum 105 via a holder 110. In this configuration, cutter element 155.3 has its cutting surface set at an angle X away from the cut material.

In addition, the cutting surface is maintained in an orientation that is not parallel to (or diverges from) a radial line, extending through the center of rotation C of the drum 105, which is perpendicular to the axis of rotation, yet the same distance to the center of rotation is maintained across the cutting edge surface.

Cutter element 155.3 has four rake faces including top rake face 190.3 (FIG. 37.15), secondary rake face 190.5 (FIG. 37.22), primary rake face 190.6 (FIG. 37.22), and a side back rake face 190.7 (FIG. 37.15). In static conditions, the top rake face 190.3 maintains an angle A of 45°±5° measured to the mounting face 212.3 of the tooth (FIG. 37.23). The primary rake face 190.6 is substantially perpendicular to the mounting face 212.3 with a length of about 0.1 to 0.3 inches, or about 0.2 inches, from the most forward tip of the tooth. The secondary rake face 190.5 is continued from the termination of the primary rake face 190.6 at an angle of 6°±5° measured from the primary rake face 190.6. An additional radius is used from the termination of the secondary rake face to provide additional clearance while cutting material. The side back rack face 190.7 is made from an arc extending from the outer most cutting tip to the main body of the cutter element. Cutter element incorporates a side clearance angle α of 7°±5° to provide extra relief while cutting. In dynamic motion, as shown in FIG. 37.23, the top rake face 190.3 maintains an angle X of about 5°-40°, 25°-30°, or about 29°±5° with respect to a line L1 running perpendicular to the axis of rotation C while the primary rake face 190.6 and secondary rake face 190.5 maintain angles Y, Z of 10°-30°, or 16°±5°, and 100-30° or 23°±5°, respectively, as measured from a line L2 which is perpendicular to line L1.

The geometry described above will result in a positive rake shearing action versus a negative rake hammering action. The positive rake on the cutting device will consume less horsepower and will be freer cutting that that of a negative rake.

Regardless of the number of multiple angled cutting edges, the resulting design allows for ease of sharpening whereby only a single surface, e.g., top rake face, needs to be touched up with a grinder to sharpen all cutting edges present. Moreover, the design is self-sharpening as any wear on the primary, secondary and/or top rake faces tends to naturally sharpen the cutting surfaces.

FIGS. 37.24-37.29 illustrate a cutter element 155.4 which is similar to cutter element 155.3, but it includes two cutting portions 175.4, one provided at each end of the main body 205.4. When one cutting portion 175.4 is spent, the cutter element 155.4 can be removed from the holder and attached in the opposite orientation (turn 180°) to position the unspent cutting portion 175.4 in the operative position.

FIGS. 37.30 and 37.31 illustrate cutter elements 155.5 and 155.6 according to alternative embodiments. Each cutter element 155.5, 155.6, respectively, includes a main body 205.5, 205.6 provided with a pair of bores, e.g., threaded blind bores which extend from a rear side 212.5, 212.6 of the main body 205.5, 205.6 towards a front side 214.5, 214.6 of the main body 205.5, 205.6.

Cutter element 155.5, 155.6 includes a cutting portion 175.5, 175.6 having a cutting edge, e.g., in the form of a serrated edge defined by a plurality of angled portions oriented towards the cutting direction D. Angled portions form peaks and valleys.

The peaks allow for point contact as opposed to linear contact which helps to step-wise chip away at and/or fracture the intended target. At the same time, valleys allow for debris to pass easily through the tooth, thus minimizing the power loss to the rotor, and/or the required power to rotate the rotor. Cutting portion may also take the form of a straight edge, or part serrated edge and part straight edge.

The front tip of the cutting edge extends forwardly of a front surface of the main body by a distance, e.g., about 5-20 mm, such that brush contacts the cutting edge before contacting the main body. Further, the cutting edge is oriented such that it is generally parallel to the target cutting surface, i.e., parallel to the cutting direction D to allow more aggressive slicing or peeling action with less horsepower.

As seen in FIGS. 37.30 and 37.31, cutter element 155.5, 155.6 includes a cross bar 200.5, 200.6 which is generally rectangular in shape. Cross bar 200.5, 200.6 extends about the width of the main body 205.5, 205.6, or slightly less, and is positioned between the threaded bores.

Cutter element 155.5, 155.6 is made of forged steel, but can also be machined or cast. The edge can be integrally included, or it can be separately attached to either the cutter portion of the main body.

The cutting edge can be supplemented with one or more strengthening layers, such a carbide insert or layer or a tungsten carbide coating (spray-on). Carbide insert layer can be mechanically attached to the cutter body, e.g., by welding, gluing, or other attachment mechanisms.

FIGS. 37.32 and 37.33 illustrate cutter elements 155.7, 155.8 according to alternative embodiments. Each cutter element 155.7, 155.8, respectively, includes a main body 205.7, 205.8 provided with a pair of bores, e.g., threaded blind bores which extend from a rear side 212.7, 212.8 of the main body 205.7, 205.8 towards a front side 214.7, 214.8 of the main body 205.7, 205.8. Also, the cutter elements 155.5, 155.6 include a cross bar 200.7, 200.8 which is generally rectangular in shape. Cross bar 200.7, 200.8 extends about the width of the main body 205.7, 205.8, or slightly less, and is positioned between the threaded bores. Each cutter element 155.7, 155.8 includes a cutting portion 175.7, 175.8, respectively.

In FIG. 37.32, the cutting portion 175.7 includes a straight cutting edge 179.7. The top surface 181.7 of the cutting portion 175.7 includes tapered or recessed portions 183.7 to allow easy passage of the cutting edge through debris. As illustrated, the tapered or recessed portions 183.7 extend from the rear side 212.7 to the front side 214.7.

In FIG. 37.33, the cutting portion 175.8 includes a straight cutting edge 179.8 with an angled cut-out 185.8 in an intermediate portion thereof. The angled cut-out 185.8 provides a valley 180.8 that allows for debris to pass easily though the cutting edge. Similar to the cutting portion 175.7, the top surface 181.8 of the cutting portion 175.8 includes tapered or recessed portions 183.8 to allow easy passage of the cutting edge through debris.

Cutter element 155.7, 155.8 is made of forged steel, but can also be machined or cast. The edge can be integrally included, or it can be separately attached to either the cutter portion of the main body.

The cutting edge 179.7, 179.8 can be supplemented with one or more strengthening layers, such a carbide insert or layer or a tungsten carbide coating (spray-on). Carbide insert layer can be mechanically attached to the cutter body, e.g., by welding, gluing, or other attachment mechanisms.

FIGS. 37.34 to 37.39 illustrate another embodiment of a cutter element 255 according to the present invention. The cutter element 255 includes a main body 205 provided with one or more bores 210 (FIGS. 37.36 and 37.39), e.g., threaded blind bores which extend from a rear side 212 of the main body 205 towards a front side 214 of the main body 205.

The cutter element 255 includes two cutting portions 275, one provided at each end of the main body 205. When one cutting portion 275 is spent, the cutter element 255 can be removed from the holder and attached in the opposite orientation (turn 180°) to position the unspent cutting portion 275 in the operative position. However, it should be appreciated that the cutter element may be provided with only one cutting portion provided at one end of the main body.

Each cutting portion 275 has a cutting edge, e.g., in the form of a serrated edge defined by a plurality of angled portions 279 oriented towards the cutting direction D, as seen in FIG. 37.37. Angled portions 279 form peaks 280.3 and valleys 280.4 as best seen in FIG. 37.35. As illustrated, the valley 280.4 is contoured or arcuate along its length.

The peaks 280.3 allow for point contact as opposed to linear contact which helps to step-wise chip away at and/or fracture the intended target. At the same time, valleys 280.4 allow for debris to pass easily through the tooth, thus minimizing the power loss to the rotor, and/or the required power to rotate the rotor. Cutting portion 275 may also take the form of a straight edge, or part serrated edge and part straight edge.

As seen in FIG. 37.38, a top surface 281 of each cutting portion 275 includes one or more grooves 283 to gauge depth of cut and to allow easy passage of the cutting edge through debris. As illustrated, the angle X between adjacent walls of the grooves is about 80°-155°, 90-105°, or about 98°, with the middle serration having a depth of about 0.1-0.5 inches, e.g., about 0.4 inches. The top surface 281 is generally curved (e.g., a radius of curvature of about 2.5 to 3.5 inches, or about 3.5 inches) from the cutting edge 277 to the rear side 212 of the main body, as can be seen in FIG. 37.39. However, the surface 281 may be linear or curvilinear, with or without relief portions, as described above. The tip of the cutting edge is raised in comparison to the rear side of the curved surface 281, e.g., by 5-30 mm. The forward most portion of each groove 283 may include a tapered or recessed portion 285 which allows even further efficiencies by allowing the cutter element to glide past debris. The recessed portion 285 is thinner than the remaining portions of the grooves.

As shown in FIG. 37.37, the front tip of each cutting edge 277 extends forwardly of a front surface of the main body by a distance A, e.g., at least a few millimeters or about 5-20 mm, such that brush contacts the cutting edge before contacting the main body 205. Further, the cutting edge is oriented such that it is generally parallel to the target cutting surface, i.e., parallel to the cutting direction D to allow more aggressive slicing action with less horsepower. The front side 281 of each cutting portion 275 forms an angle B with horizontal of about 30°-70°, or about 42.5°.

Main body 205 may have a truncated pyramid shape having lateral walls 216, wall 218 and wall 220 that are angled to allow the main body 205 to deflect debris. Each wall 218, 220 may help to define a U- or L-shaped channel 222 (FIG. 37.37) which together with the forwardly oriented cutting edge 277 defines a scoop type structure, to maximize ease of cutting and cutting depth. However, the truncated pyramid shape is not necessary, as the front side 214 of the main body 205 can be generally flat and blend with the cutting portion 275 without a scoop like configuration.

As seen in FIG. 37.39, the threaded bores 210 may extend into the main body 205 to a depth which reaches the truncated pyramid section. This provides for extra threaded length to ensure that the cutter element 255 is properly secured to the holder.

As seen in FIG. 37.35, the width W of the edge 277 is greater than the width w of the main body 205 of the cutter element. For example, the edge width W may be at least about 5% or 5-70% (or about 50%) greater than the width of the main body 205. Width W defines an effective cutting width of about 2-3 inches, e.g., about 2.5-2.7 inches, with a height H (FIG. 37.38) of about 1-3 inches, e.g., 2 inches, measured from the mounting face to the forward most tip. The width w may be about 1-3 inches, e.g., 2 inches. The edge 277 can also have the same width as the main body 205, or it can even be narrower, if desired.

The cutter element 255 includes a cross bar 200 which is generally rectangular in shape. Cross bar 200 extends about the width of the main body 205, or slightly less, and is positioned between the threaded bores 210. A middle portion 224 of the cross bar may be slightly necked down to maximize the dimensions of the cross bar 200 while accommodating the threaded bores 210 (see FIG. 37.36).

Cutter element 255 is made of forged steel, but can also be machined or cast. The edge 277 can be integrally included, or it can be separately attached to either the cutter portion 275 of the main body 205.

The cutting edge 277 can be supplemented with one or more strengthening layers, such as a carbide, tungsten-carbide or tungsten insert, deposit or layer or a tungsten-carbide coating (e.g., diffused or spray-on). A tungsten-carbide insert layer can be mechanically attached to the cutter body, e.g., by welding, gluing, or other attachment mechanisms. The cutter element or portions thereof may also be case hardened, e.g., to Rockwell 60 hardness.

In one example, a tungsten carbide layer can be sprayed on to the inner surface 290.3 and/or the top surface 281 of the cutting portion 275. The tungsten carbide can extend to the tips of the serrated edge and even cover the angled surfaces 279. In another example, a tungsten or tungsten carbide insert can be welded to the inner surface (or top rake face) 290.3 and/or the top surface 281—or the insert can be positioned within a notch formed in the cutting portion 275. If strengthening layer is applied (e.g., welded) only on the inner surface 290.3, the cutting edge can be self sharpening since the parent steel material on the top surface 281 of the cutting portion 275 will wear away until reaching the carbide layer, at which point the wearing away will occur at a much slower pace yet the cutting edge will remain sharp.

Cutter element 255 has four rake faces including top rake face 290.3, secondary rake face 290.5, primary rake face 290.6, and a side back rake face 290.7 (e.g., FIGS. 37.34 and 37.38). In static conditions, the top rake face 290.3 maintains an angle of 42.5°±5° measured to the mounting face of the tooth. The primary rake face 290.6 is substantially perpendicular to the mounting face 212 with a length of about 0.1 to 0.5 inches, or about 0.3 to 0.4 inches, from the most forward tip of the tooth. The secondary rake face 290.5 is continued from the termination of the primary rake face 290.6 at an angle of 6°±5° measured from the primary rake face. An additional radius is used from the termination of the secondary rake face to provide additional clearance while cutting material. The side back rack face 290.7 is made from an arc extending from the outer most cutting tip to the main body of the cutter element. Cutter element incorporates a side clearance angle a of 7°±5° to provide extra relief while cutting.

FIGS. 37.40 to 37.46 illustrate another embodiment of a cutter element 355 according to the present invention. The cutter element 355 includes a main body 305 provided with at least one bore 310 (FIGS. 37.42 and 37.45), e.g., threaded blind bores which extend from a rear side 312 of the main body 305 towards a front side 314 of the main body 305.

The cutter element 355 includes a cutting portion 375 at one end of the main body 305. The cutting portion 375 has a cutting edge 377, e.g., in the form of a serrated edge defined by a plurality of angled portions 379 oriented towards the cutting direction D, as seen in FIG. 37.43. Angled portions 379 form peaks 380.3 and valleys 380.4 as best seen in FIG. 37.41. However, cutting portion 375 may also take the form of a straight edge, or part serrated edge and part straight edge.

Cutter element 355 is made of forged steel, but can also be machined or cast. In the illustrated embodiment, the cutting edge 377 is provided as an insert (e.g., carbide insert) that can be mechanically attached to the cutter portion 375 of the main body 305, e.g., by welding, gluing, or other attachment mechanisms. For example, the insert may be mechanically attached to the inner surface (or top rake face) 390.3. In an embodiment, the insert may be positioned within a notch formed in the cutting portion 375.

As seen in FIG. 37.46, a top surface 381 of each cutting portion 375 includes one or more grooves 383 to gauge depth of cut and to allow easy passage of the cutting edge through debris. As shown in FIG. 37.44, the angle X between adjacent walls of the grooves is about 80°-155°, 90-105°, or about 98°, with the middle serration having a depth of about 0.1-0.7 inches, e.g., about 0.5-0.6 inches. The top surface 381 is generally curved (e.g., a radius of curvature of about 2.5 to 3.5 inches, or about 3.5 inches) from the cutting edge 377 to the rear side 312 of the main body, as can be seen in FIG. 37.43. The tip of the cutting edge is raised in comparison to the rear side of the curved surface 381, e.g., by 5-30 mm. The forward most portion of each groove 383 may include a tapered or recessed portion 385 which allows even further efficiencies by allowing the cutter element to glide past and through debris. The recessed portion 385 is thinner than the remaining portions of the grooves.

As shown in FIG. 37.43, the front tip of each cutting edge 377 extends forwardly of a front surface of the main body by a distance A, e.g., at least a few millimeters or about 5-20 mm, such that brush contacts the cutting edge before contacting the main body 305. Further, the cutting edge is oriented such that it is generally parallel to the target cutting surface, i.e., generally parallel to the cutting direction D to allow more aggressive slicing action with less horsepower. For example, as shown in the enlarged view of FIG. 37.43, the cutting edge may extend at an angle β of about 0-10°, e.g., about 5°, with respect to vertical. The front side of each cutting portion 375 forms an angle B with horizontal of about 30°-70°, or about 40°.

Main body 305 may have a truncated pyramid shape having lateral walls 316, upper wall 318 and lower wall 320 that are angled to allow the main body 305 to deflect debris. The front wall 318 may help to define a U- or L-shaped channel 322 (FIG. 37.43) which together with the forwardly oriented cutting edge 377 defines a scoop type structure, to maximize ease of cutting and cutting depth. However, the truncated pyramid shape is not necessary, as the front side 314 of the main body 305 can be generally flat and blend with the cutting portion 375 without a scoop like configuration.

As seen in FIG. 37.41, the width W of the edge 377 is greater than the width w of the main body 305 of the cutter element. For example, the edge width W may be at least about 5% or 5-70% (or about 50%) greater than the width of the main body 305. Width W defines an effective cutting width of about 2-3 inches, e.g., about 2.5 to 2.7 inches, with a height H (FIG. 37.44) of about 1-3 inches, e.g., 2 inches, measured from the mounting face 312 to the forward most tip. The width w may be about 1-3 inches, e.g., 2 inches. The edge 377 can also have the same width as the main body 305, or it can even be narrower, if desired.

The cutter element 355 includes a cross bar 300 which is generally rectangular in shape. Cross bar 300 extends about the width of the main body 305, or slightly less, and is positioned between the threaded bores 310. A middle portion 324 of the cross bar may be slightly necked down to maximize the dimensions of the cross bar 300 while accommodating the threaded bores 310 (see FIG. 37.42).

Cutter element 355 has four rake faces including top rake face 390.3, secondary rake face 390.5, primary rake face 390.6, and a side back rake face 390.7 (e.g., FIGS. 37.40 and 37.46). In static conditions, the top rake face 390.3 maintains an angle of 40°±5° measured to the mounting face of the tooth. The primary rake face 390.6 is substantially perpendicular to the mounting face 312 with a length x of about 0.1 to 0.5 inches, or about 0.2-0.3 inches, from the most forward tip of the tooth (see enlarged view of FIG. 37.43). The secondary rake face 390.5 is continued from the termination of the primary rake face 390.6 at an angle of 6°±5° measured from the primary rake face. An additional radius is used from the termination of the secondary rake face to provide additional clearance while cutting material. The side back rack face 390.7 is made from an arc extending from the outer most cutting tip to the main body of the cutter element. Cutter element incorporates a side clearance angle a of 7°±5° to provide extra relief while cutting.

FIGS. 38-40 illustrate yet another embodiment of a holder 110 according to the present invention. The embodiment of FIGS. 38-40 is similar to the embodiment of FIGS. 23-25, except that the notch portion 150 is provided in alignment with one of the bores 145, in this case the upper bore 145.

FIGS. 41-43 illustrate yet another embodiment of a holder according to the present invention. This embodiment is similar to that shown in FIGS. 38-40, except for only a single bore 145 is provided in the holder.

FIGS. 44-51 illustrate embodiments of cutter elements adapted for use with the holder embodiment shown in FIGS. 38-43. The embodiment of FIGS. 44-47 is similar to the embodiment of FIGS. 26-29, except for a single bore, e.g., through bore 210, is provided in the embodiment of FIGS. 44-47. In addition, the through bore 210 is in alignment with the cross bar 200 as compared to being offset with respect to the cross bar. Where the bore 210 passes through the cross bar, the cross bar preferably has a width at least equal to, and preferably wider than, the diameter of the bore. The cross bar should preferably extend over the entire width of the main body of the cutter element, although that is not necessary. Accordingly, the through bore 210 aligns with the through bore 145 in the holder embodiments of FIGS. 38-43.

The embodiment of FIGS. 44A-47A is similar to the embodiment of FIGS. 44-47. However, the cutter element in FIGS. 44A-47A includes lateral wing portions 201 on each side of the cross bar 200, for purposes of stability. In order to facilitate use with holder 195 shown in FIGS. 41-43, notch portion 150 may be provided with side notch portions 151 that are dimensioned to receive lateral wing portions 201.

The embodiment of FIGS. 48-51 is similar to the embodiment shown in FIGS. 30-33 except that a single bore, e.g., through bore 190, is provided in the embodiment of FIGS. 48-51. The through bore 190 is provided in alignment with the cross bar 200. Accordingly, the through bore 190 in the embodiment of FIGS. 48-51 aligns with the through bore 145 in the embodiments of the holder shown in FIGS. 38-43.

FIGS. 53-63 illustrate embodiments of an adapter according to the present invention. The adapter is intended to be used where the interfacing surfaces of a given cutter element and a given cutter element engagement portion of a holder are incompatible. For example, if the holder is provided with an oval shaped recessed aperture 140, but without the notch portions 150 shown in FIG. 7a, and the cutter element is provided with only a cross bar, the use of an adapter would be appropriate. Of course, the adapter could be used even if the cutter element and holder are compatible, e.g., to render the cutting tip offset with respect to the other cutter tips.

The embodiment of FIGS. 52-54 shows an adapter 300 including a main body 305 provided with a centrally located notch portion 310 and shroud 318. The shroud 318 includes at least one and preferably a pair of threaded bores 320. The threaded bores 320 can be either through bores or blind bores, although through bores are shown in FIGS. 52 and 53. This embodiment is useful for cutter elements that include a cutting tip portion provided on one end of the main body 305. However, the adapter 300 shown in FIGS. 52-54 can also be used with cutter elements having cutting tip portions provided on each end of the main body 305.

FIGS. 55-57 illustrate another embodiment of an adapter 400 according to the present invention. The adapter 400 includes a centrally located notch portion 405 and an asymmetrically oriented shroud 410. This embodiment is particularly useful when it is desired to offset the tip portion of a cutter element with respect to the base portion of the holder, e.g., when using a double ended cutter element.

In the embodiment of FIGS. 58-60, an adapter 500 is provided with a centrally located notch 505. Instead of the shroud 410 of the embodiments of FIGS. 52-54, the embodiment of FIGS. 58-60 includes a pair of cylindrical extensions 510 which are intended to meet with either a pair of separate apertures or a single oval shaped aperture provided in the holder. In addition, the adapter 500 may include one or more cross bars 521, 523, 525 provided adjacent to or between the cylindrical extensions 510.

The embodiment of FIGS. 61-63 shows an adapter 600 having a main body 605 including a centrally located notch 610. The main body 605 is also provided with a shroud 615 as well as a cross bar 620. This embodiment of the adapter 600 is particularly useful for use with the holder as shown in FIGS. 7a-10.

In yet another embodiment, the adapter may simply include one or more cross bars 521, 523, 525 (FIGS. 58-60) and/or 620 (FIGS. 61-63), without cylindrical extensions, a shroud, etc. See, e.g., FIG. 58A.

FIGS. 64-69A illustrate variations of the shape of the cross bars shown in FIGS. 37.1-37.14, which is illustrated as rectangular or square in cross-section. In particular, the cross-sectional shape of the cross bar may include, for example, a tapered shape as shown in FIG. 64, a ramped shape as shown in FIG. 65, a part rectangular and part curved or arch shape as shown in FIG. 66, a fully arcuate or semi-circular shape as shown in FIG. 67, an arrow shape as shown in FIG. 68, an inverse cut as shown in FIG. 69, a Woodruff key assembly as shown in FIG. 69A, or a combination thereof. In the case of FIG. 69A, the Woodruff key assembly 800 includes a Woodruff key 802 having a first end 804 that is seated within a groove of the holder, and a second end 806 that is cured and dimensioned to fit with a similarly shaped groove 807 in the rear wall 808 of the main body 810 of the cutter element 812. Of course, the Woodruff key assembly can be positioned in other locations, and/or more than one Woodruff key assembly may be provided. Also, the flat first end 804 can be positioned in the rear wall 808 of the cutter element 812, and the curved second wall 806 can be received with a recess in the holder.

FIG. 70 is an exploded view of a holder 110 having a standard oval shaped aperture 140, an adapter 300 having an oval shaped shroud 360 for engagement with the aperture 140, a notch portion 150, and the cutter element 155.1 of FIGS. 37-1-37.7 including a cross bar for engagement with the notch portion 150 of the adapter 300. FIG. 71 is an assembled view of the holder 100, adapter 300 and cutter element 155.1 shown in FIG. 70.

FIG. 72 is an exploded view of a holder 110 having a cross cut notch portion 150 and the cutter element 155.1 including a cross bar for engagement with the notch portion 150 in the holder. In FIG. 72, holder may include up to three threaded or non-threaded bores, while cutter element 155.1 may include one or more blind threaded bores aligned with at least one of the bores in the holder 110. FIG. 73 is an assembled view of the holder 110 and cutter element 155.1 shown in FIG. 72.

FIG. 74 illustrates yet another embodiment of the present invention, usable with the cutter body as disclosed in U.S. Pat. No. 5,582,353, incorporated herein by reference. FIG. 74 shows a holder 400 that is intended to be mounted on a base element (not shown) that is fixedly mounted on a rotating cylindrical drum (not shown). The holder 400 includes a main body 405 including a pair of depending legs 410 having a space 415 therebetween. The base element on the rotating drum is intended to be positioned within the space 415. Upon alignment of through bores 420 (only one shown) in the legs 410 with a through bore in the base element, a connection element, e.g., a bolt, is threaded through the aligned bores to fix the holder 400 to the base element in a non-notable fashion. The fixed angular position of the holder 400 may be selectively adjusted to change the angle at which the cutter element 425 impacts or contacts the target.

The holder 400 includes a head portion 430 including a notch portion 435 extending across a leading face 440 of the head portion 430. The notch portion 435 is intended to receive and mate with a cross bar 445 provided on the cutter element 425. As an alternative, or in addition to the notch portion 435, the leading face 440 may be provided with a vertical notch portion 450 intended to receive and mate with a vertical bar or key portion 455 provided on the cutter element 425. Moreover, the embodiments described above may include a vertical key portion 455 in addition to or as an alternative to the shroud and cross bar arrangements described above. Of course, the geometrical configurations are possible, e.g., star shaped, X-shaped, etc., all of which help prevent relative rotation between the cutter element 425 and the holder 400.

The cutter element 425 in other respects is similar to that described in relation to FIGS. 44-47 described above. For example, the cutter element 425 includes a bore, e.g., a through bore 460, that extends through the cross bar 445 so as to receive a threaded bolt that extends through a bore 465 in the head portion 430 of the cutter element 400. Further, the head portion 430 may include a cut out portion 470 to allow debris to easily pass between adjacent leg portions 475 of the head portion 430.

The embodiment of FIG. 74 is advantageous because it provides for quick replacement of spent cutter elements with replacing the entire holder assembly. The cutter element 425 may include tip portions at each end so that the cutter element 425 may be removed and rotated 180° to place the unspent end in the cutting position.

The holder 410 and cutter element 425 may be modified to include any of the arrangements described above, and vice versa, without departing from the spirit of the invention. For example, as shown in FIG. 75 instead of an arrangement where the through bores 460 and 465 are aligned with the cross bar 445, one or a pair of bores may be provided in offset arrangement relative to the cross bar, as shown in various embodiments above, e.g., FIGS. 11-22c and 26-37. In addition, the cutter element and holder may be used with an adapter as described above, see, e.g., FIGS. 52-63. Finally, bore 420′ can be formed of a non-circular or polygonal cross-section, so as to positively lock holder 410 against rotational movement when engaged with locking pin 401. In this case, a support bracket 451, which is fixed or otherwise provided to a rotating drum, may include a square (or other complementary non-circular) aperture 453.

FIGS. 76-79 show an adapter 900 according to another embodiment of the present invention. As shown in FIG. 76, the adapter includes a head portion 902 and a forwardly oriented surface 904 that includes through bores 906 and 908, as well as a threaded bore 910 which may be a blind bore or a through bore. Through bores 906 and 908 align with through or blind threaded bores in cutter element 600. Bores 906 and 908 are preferably non-threaded, although they could have threads if desired. The forward surface 904 also includes a notch 912 which is adapted to receive a cross bar of a cutter element.

A rear surface 913 of the adapter 900 includes first and second cylindrical extensions which align with respective apertures 140′ (FIG. 80).

The head portion 902 of the adapter 900 includes a rearwardly extending ledge portion 918 which is configured to rest or be positioned above a top surface 111 of holder 110. See FIG. 80.

FIGS. 77-79 illustrate additional views of the holder, while FIG. 81 shows the holder assembled together with the adapter 900 and an exemplary tooth 600. Of course, any tooth configured with a cross bar generally as shown in FIG. 80 can be used with the adapter 900. For example, the cutter element shown in FIGS. 30A-33A can be used with the adapter 900.

It is noted that one or more of the above-described cutter elements may be structured to provide a design that allows for ease of sharpening. In addition, one or more of the above-described cutter elements may be structured to provide a design with less drag, which facilitates passage of the cutting edge through debris in use.

While the invention has been described in conjunction with illustrated embodiments thereof, it is evident that many alternatives, modifications and variations may be apparent to those skilled in the art. For example, while the cutting assemblies include cutter elements which can be separated from their respective holders, it is also possible that the cutter elements be provided as an integral portion with the respective holder portion and that the holder portion be selectively removable from the rotor, for example. In addition, one or more components of one embodiment of a first holder and/or cutter element can be combined with one or more components of another holder and/or cutter element, to result in additional embodiments. Further, while the holder has been described as including notch portions, and the cutter element has been described as including the cross bar, the positioning of the notch portions and the cross bar can be reversed. Further, various aspects of the embodiments disclosed herein may include one or more ornamental design features. Accordingly, embodiments of the invention as set forth herein are intended to be illustrative, not limiting. Various changes may be made without departing from the spirit and scope of the present invention.

What is claimed is:

1. A cutter element for a mulcher apparatus, comprising:
a main body including a rear portion configured to be mounted on a cutter element receiving surface of a holder and a front portion including at least one cutting portion, said rear portion including at least one bore provided in the main body, wherein the cutting portion includes a serrated edge extending at least partially across a width of the main body.

2. The cutter element of claim 1, further comprising a cross bar provided to and extending from the rear portion of the main body, said cross bar being structured to engage with a notch portion on the holder, said cross bar being positioned adjacent the at least one bore.

3. The cutter element according to claim 1, wherein the serrated edge has a width that is greater than the width of the main body.

4. The cutter element of claim 3, wherein the width of the serrated edge is at least 5%-30% greater than the main body width.

5. The cutter element according to claim 1, wherein the main body includes first and second ends each including at least one said serrated edge.

6. The cutter element according to claim 1, wherein a front side of the main body has a truncated pyramid portion with angled lateral, upper and lower walls.

7. The cutter element of claim 6, wherein the at least one bore extends into the truncated pyramid portion, and the bore is a threaded blind bore.

8. The cutter element according to claim 6, further comprising a channel formed between the cutter tip portion and the main body.

9. The cutter element as claimed in claim 2, wherein the cross bar includes a central necked down portion.

10. The cutter element according to claim 1, wherein the cutting portion includes a top surface that is curved or angled from the serrated edge towards a rear side of the main body, such that a trailing edge of the top surface is lower than a leading edge thereof, as seen in the cutting direction.

11. The cutter element of claim 10, wherein the top surface includes one or more grooves.

12. The cutter element of claim 11, wherein each groove includes a tapered or recessed portion adjacent the serrated edge.

13. The cutter element according to claim 1, wherein the main body is formed of cast, machined or forged materials.

14. The cutter element of claim 13, wherein each serrated edge includes a notch to receive a carbide tip insert provided to the notch, or the serrated edge is in the form of a carbide insert structured to be attached to the cutting portion.

15. The cutter element according to claim 1, wherein the cutting portion includes a top surface and an inside surface with the serrated edge positioned therebetween, and wherein a strengthening layer is provided to the top surface and/or the inside surface.

16. A cutter element for a mulcher apparatus, comprising:
a main body including a rear portion configured to be mounted on a cutter element receiving surface of a holder and a front portion including at least one cutting portion, wherein the cutting portion includes a top surface that is positioned towards the rear portion of the main body such that a tip or leading edge of the cutting portion is higher than the rear portion of trailing edge of the main body.

17. The cutter element of claim 16, wherein the top surface includes one or more grooves to gauge depth of cut of the cut material.

18. The cutter element of claim 17, wherein each said groove includes a recessed or tapered portion provided adjacent the tip of the cutting portion.

19. The cutter element of claim 16, wherein the tip of the cutting portion extends forward of a front surface of the main body by a predetermined amount.

20. A cutting portion for a mulcher apparatus, comprising:
a main body including a rear portion configured to be mounted on a cutter element receiving surface of a holder and a front portion including at least one cutting portion, wherein the cutting portion has a cutting edge that is wider than the main body.

21. The cutter element of claim 20, wherein the cutting edge is serrated.

22. A tooth assembly for a mulcher apparatus, comprising:
a holder including a base portion adapted to be connected to the mulcher apparatus and a head portion provided opposite the base portion, the head portion being provided with a cutter element receiving surface including at least one notch portion; and
the cutter element according to claim 1.

23. The tooth assembly of claim 22, wherein the holder includes at least a first holder bore extending from a front wall of the cutter element receiving surface to a trailing edge of the head portion, and the at least one bore of the cutter element aligns with the first holder bore upon engagement of the at least one notch and the cross bar.

24. The tooth assembly of claim 23, wherein the holder includes a second holder bore and a second bore of the cutter element aligns with the second holder bore upon engagement between the at least one notch and the cross bar.

25. The tooth assembly of claim 23, wherein the first bore of the cutter element is offset from the cross bar.

26. The tooth assembly according to claim 22, wherein the cutter element receiving surface of the holder includes a front wall portion and a bottom wall portion that form a step like configuration to cradle bottom and rear walls of the cutter element.

27. The tooth assembly according to claim 22, further comprising an adapter interposed between the holder and the cutter element.

28. The tooth assembly of claim 27, wherein the adapter element includes the cutter element receiving surface with the at least one notch.

29. A mulcher apparatus comprising:
a tractor with one or more wheels and/or tracks;
a mulcher unit coupled to the tractor, the mulcher unit including a rotor; and
at least one cutter element as set forth in claim 1 coupled to the rotor.

30. The mulcher apparatus of claim 29, wherein the rotor includes a plurality of rows of tooth assemblies.

31. A mulcher apparatus comprising:
a tractor with one or more wheels and/or tracks; and
a mulcher unit coupled to the tractor, the mulcher unit including the tooth assembly of claim 22.

32. A cutter element for a mulcher apparatus comprising a main body including a front portion defining a front surface and at least one cutting portion, said cutting portion having a tip that extends forward of the front surface along a cutting direction so that the tip defines a cutting surface that, in use, is angled inwards towards a rear surface of the main body, away from material to be cut.

33. The cutter element of claim 32, wherein the angle is about 5°-40°.

34. The cutter element of claim 33, wherein the angle is about 25°-35°.

35. The cutter element of claim 33, wherein the angle is measured from a line running from the tip to the axis of rotation of the cutter element.

36. A mulcher apparatus comprising:
a drum defining an axis of rotation; and
at least one cutter element provided to the drum, said cutter element including a cutting surface,
wherein the cutting surface is not parallel to a radial line that is perpendicular to and intersects the axis of rotation.

37. The mulcher apparatus of claim 36, wherein the cutting surface at a tip of the cutter element is set forward in the cutting direction compared to a base portion of the cutter element.

38. A cutter element for a mulcher apparatus comprising:
a main body having a mounting face and a front face defining at least one tooth having a tip;
a primary rake face extending from the tooth tip; and
a secondary rake face continuing from and angled with respect to the primary rake face.

39. The cutter element of claim 38, further comprising a pair of side back rake faces each extending from an outermost cutting tip to the main body.

40. The cutter element of claim 38, further comprising a top rake face which is angled 40°±5° relative to the mounting face.

41. The cutter element of claim 38, wherein the top rake face maintains an angle of about 5°-40° relative to a line extending between the tip and an axis about which the cutter element is configured to rotate.

42. The cutter element of claim 41, wherein the angle is about 25°-30°.

43. The cutter element of claim 38, wherein the secondary rake face is angled about 6°±5° relative to the primary rake face.

44. The cutter element of claim 38, wherein the primary rake face has a length of about 0.1-0.4 inches.

45. The cutter element of claim 44, wherein the length is about 0.2 inches.

46. The cutter element of claim 38, wherein the side walls of the main body are angled approximately 7°±5°.

47. The cutter element of claim 38, wherein the primary rake face maintains an angle of about 10°-30° relative to a line extending perpendicular to a line extending between the tip and an axis about which the cutter element is configured to rotate.

48. The cutter element of claim 47, wherein the angle is about 16°±5°.

49. The cutter element of claim 38, wherein the secondary rake face maintains an angle of about 10-30° relative to a line extending perpendicular to a line extending between the tip and an axis about which the cutter element is configured to rotate.

50. The cutter element of claim 49, wherein the angle is about 23°±5°.

51. The cutter element of claim 38, wherein the primary and/or secondary rake faces include one or more grooves to facilitate passage of the cutting edge through debris and to define depth of cut of the cut material.
